(19) United States
(12) Patent Application Publication
(10) Pub. No.: US 2024/0181588 A1
(43) Pub. Date: Jun. 6, 2024

(54) MITER GAUGES AND FENCES

(71) Applicant: SawStop Holding LLC, Tualatin, OR (US)

(72) Inventors: Stephen F. Gass, West Linn, OR (US); Alexander J. Hawkinson, Beaverton, OR (US)

(73) Assignee: SawStop Holding LLC, Tualatin, OR (US)

(21) Appl. No.: 18/388,120

(22) Filed: Nov. 8, 2023

Related U.S. Application Data
(60) Provisional application No. 63/423,543, filed on Nov. 8, 2022.

(51) Int. Cl. B23Q 16/06; B23Q 17/22; B27B 25/10; B27G 5/02

(52) U.S. Cl. CPC B23Q 16/06; B23Q 17/22; B27B 25/10; B27G 5/023

(57) ABSTRACT

A miter gauge with discrete indices is disclosed. The indices allow a user to make precise, accurate adjustments to the miter angle of the miter gauge. The miter gauge may include a plurality of sets of indices with discrete steps of different amounts. The miter gauge may include a drive to adjust the miter angle. The drive may include a gear. A reversible miter fence is also disclosed. The miter fence may optionally be used with the miter gauge to provide a larger workpiece support surface. A flip stop mechanism is also disclosed. The flip stop mechanism may optionally be used with the miter fence to provide a reference surface for positioning a workpiece.

### CROSS-REFERENCE TO RELATED APPLICATION

This application claims the benefit of and priority from U.S. Provisional Patent Application Ser. No. 63/423,543, filed Nov. 8, 2022, which is incorporated herein by reference.

### FIELD

The present disclosure relates generally to miter gauges and fences used with workpiece shaping tools, and more particularly to miter gauges and fences with an ability for fine adjustment and precise alignment and positioning of workpieces.

### BACKGROUND

When shaping, cutting, or otherwise processing a workpiece with a table saw or other type of workpiece shaping tool, it can be difficult to make precise, repeatable, or angled cuts. While some processes utilize the help of a rip fence that runs parallel to the plane of the blade to guide the workpiece, there are often workpieces or processes that benefit from a different guide. One such guide that is known in the art is a miter gauge. Some miter gauges have a guide bar that fits into and slides within a channel or groove on a worksurface, and have a support or fence attached to the guide bar. The support or fence is usually configured to pivot relative to the guide bar, allowing a user to make an angled cut on a workpiece. However, the miter gauges and fences known in the art have not sufficiently met the need of being simple and accurately adjustable to precisely position and orient a workpiece for shaping. The miter gauges and fences disclosed herein allow the position and angle of the workpiece to be simply adjusted with both accuracy and precision.

### BRIEF DESCRIPTION OF THE DRAWINGS

FIG. 1 shows a perspective view of a table saw with an exemplary miter gauge.

FIG. 2 shows a top view of a table saw with the exemplary miter gauge.

FIG. 3 shows a partially exploded view of the exemplary miter gauge.

FIG. 4 shows an exploded view of a portion of the exemplary miter gauge.

FIG. 5 shows a cross sectional view of the exemplary miter gauge taken along the elongate center axis of the miter bar.

FIG. 6 shows an exploded view of another portion of the exemplary miter gauge.

FIG. 7 shows a cropped view of the exemplary miter gauge with a cut-away portion in a dashed circle.

FIG. 8 shows a cropped, close-up view of the exemplary miter gauge.

FIG. 9 shows an enlarged callout view of a portion of FIG. 8.

FIG. 10 shows an enlarged callout view of another portion of FIG. 8.

FIG. 11 shows an enlarged view of FIG. 10.

FIG. 12 shows a cropped view of the exemplary miter gauge adjusted to one particular miter angle, and with a close-up view of one portion shown in a circular callout.

FIG. 13 shows a cropped view of the exemplary miter gauge adjusted to a different miter angle, and with a close-up view of one portion shown in a circular callout.

FIG. 14 shows a cropped perspective view of the underside of the exemplary miter gauge.

FIG. 15 shows an exemplary detent surface.

FIG. 16 shows an exploded view of additional portion of the exemplary miter gauge.

FIG. 17 shows a perspective view of the underside of an exemplary detent selector knob.

FIG. 18 shows a top view of an exemplary detent selector carriage.

FIG. 19 shows a cropped view of the exemplary miter gauge in one orientation with the detent selector knob in dashed outline form to reveal the underlying structures.

FIG. 20 shows a cropped view of the exemplary miter gauge in a different orientation with the detent selector knob in outline form to reveal the underlying structures.

FIG. 21 shows an enlarged cross section of a portion of an alternative miter angle indicator plate.

FIG. 22 shows a perspective view of a portion of an alternative miter gauge.

FIG. 23 shows the detent selector carriage of the alternative miter gauge of FIG. 22.

FIG. 24 shows a cropped, exploded view of the alternative miter gauge of FIG. 22.

FIG. 25 shows a partially exploded view of the exemplary miter gauge and an exemplary miter fence assembly.

FIG. 26 shows a cropped cross section of the assembled miter gauge and fence assembly.

FIG. 27 shows a cropped perspective view of the miter gauge and fence assembly with a sample workpiece.

FIG. 28 shows an exploded view of an exemplary flip stop mechanism of the exemplary fence assembly.

FIG. 29 shows a perspective view of an exemplary flip stop clamp assembly with the clamp base and clamp jaw in dashed outline form to reveal the internal mechanism.

FIG. 30 shows a side view of the exemplary fence assembly with the flip stop mechanism in a clamped condition, and with the clamp assembly and upper rail shown in cross section through the center of the clamp piston bolt.

FIG. 31 shows a side view of the exemplary fence assembly with the flip stop mechanism in an unclamped condition, and with the clamp assembly and upper rail shown in cross section through the center of the clamp piston bolt.

FIG. 32 shows a perspective view of the exemplary miter gauge and fence assembly with the upper rail in an extended position, and also including a zoomed view of the rulers in a circular callout.

FIG. 33 shows a side view of the fence assembly with the flip stop mechanism removed and with the upper rail in a locked condition relative to the lower rail.

FIG. 34 shows a side view of the fence assembly with the flip stop mechanism removed and with the upper rail in an unlocked condition relative to the lower rail.

FIG. 35 shows a cropped view of the exemplary fence assembly with the rail lock mechanism in exploded form.

FIG. 36 shows a cropped view of the exemplary fence assembly in cross section taken through the elongate center axis of the lower rail.

FIG. 37 shows a cropped perspective view of the end of the lower rail which houses the rail lock mechanism.

FIG. 38 shows a cropped view of the exemplary fence assembly with the rails partially cut away to reveal the rail lock mechanism.

FIG. 39 shows a cropped view of the exemplary fence assembly with a sample workpiece in contact with the micro-adjust mechanism of the exemplary flip stop mechanism.

FIG. 40 shows a cropped view of the exemplary miter gauge and fence assembly with the flip stop mechanism in a non-operative position.

FIG. 41 shows a perspective view of the exemplary miter gauge and fence assembly with the flip stop mechanism in an operative position against a sacrificial fence.

FIG. 42 shows a cropped side view of the flip stop mechanism against the sacrificial fence.

FIG. 43 shows a cropped view of the exemplary miter gauge and fence assembly on a table saw, where the exemplary fence assembly is mounted to the exemplary miter gauge in a reverse position relative to FIG. 27.

### STATEMENTS CONCERNING THIS DISCLOSURE

The present disclosure describes various exemplary embodiments of workpiece shaping tools, power tools, and accessories therefor. The embodiments as disclosed and illustrated herein are not to be considered in a limiting sense as numerous variations and combinations are possible. Rather, the various exemplary embodiments depicted in the drawings and described in detail below are intended to illustrate specific examples and implementations in a variety of different contexts. It will be understood by those of skill in the art that many different variations, modifications, alternatives, combinations, and equivalents of these particular exemplary embodiments are possible. Therefore, the drawings and detailed description are not intended to limit the scope of the claims to the forms, arrangements, components, and/or configurations depicted and described therein. Instead, the drawings and detailed description are intended to cover all such variations, modifications, alternatives, combinations, and equivalents as are described and suggested within the scope and spirit of the disclosure and as are defined by the claims.

While references to “exemplary embodiment”, “alternative embodiments”, “other embodiments”, etc., may appear throughout the disclosure, repeated occurrences of such references are not intended necessarily to refer to the same embodiment(s). Rather, such references should be understood in the context in which they are provided and with reference to the figures and components with which they are associated within the narrative of the disclosure. Furthermore, reference to certain embodiments is not intended to exclude other embodiments since particular components, elements, circuits, structures, assemblies, processes, and methods described herein may be combined and/or modified in any manner that is suitable and consistent with the disclosure.

This disclosure sometimes refers to structural elements as being “configured to,” or “adapted to,” perform one or more tasks, operations, or functions. Such elements may be referred to as “components,” “assemblies,” “mechanisms,” etc. It should be understood that when such an element is described as being “configured to” or “adapted to” perform such a task or etc., this phrasing is intended to refer to a physical object or structure such as a mechanical component (e.g., arm, bracket, shaft, mount, housing, etc.), or a plurality of such components interconnected or combined into a mechanism or assembly. Furthermore, the phrasing “configured to” or “adapted to” perform a particular task or etc., is intended to indicate that the structural component or combination of components is arranged, positioned, selected, connected, combined and/or designed to perform the particular function stated. Thus, for example, the phrase “a component configured to be operated by a person or user” means a component that is sized, shaped, positioned, and designed so as to be readily engaged, moved, or otherwise manipulated by a person of average size and capability in order to achieve an intended result. Therefore, it should be understood that all references herein of some particular element being “configured to” or “adapted to” perform some operation, task, or function refers to a physical object and not to some intangible entity, process, or function.

If used herein, the terms “first,” “second,” etc., when used to modify structural elements, are not intended to describe any temporal or spatial order or priority, unless such order or priority is expressly stated. Thus, for example, the terms “first component” and “second component” do not, unless otherwise stated, imply that the component referred to as the “first component” has any priority or control over the component referred to as the “second component.” Furthermore, the terms are not intended to imply that the two components are either identical or non-identical unless explicitly described as such. Instead, the terms are solely intended to convey the presence of two, separate physical components.

Unless otherwise stated explicitly, the terms “user” and “operator,” when used herein in reference to using or operating a mechanism such as a power tool, are identical and interchangeable. In contrast, the term “person” means any person whether or not the person is using or operating the mechanism in question.

In the drawings and description herein, numerous specific details are disclosed for a variety of exemplary embodiments to provide a complete and thorough understanding to those of skill in the art. Nevertheless, those of skill in the art will recognize that many aspects of the present disclosure can be practiced without one or more of the specific details. In some embodiments, well-known and/or readily available components, structures, assemblies, and techniques may have not been shown in detail to avoid unhelpful complexity which might hinder comprehension of the present disclosure in its entirety.

### DETAILED DESCRIPTION

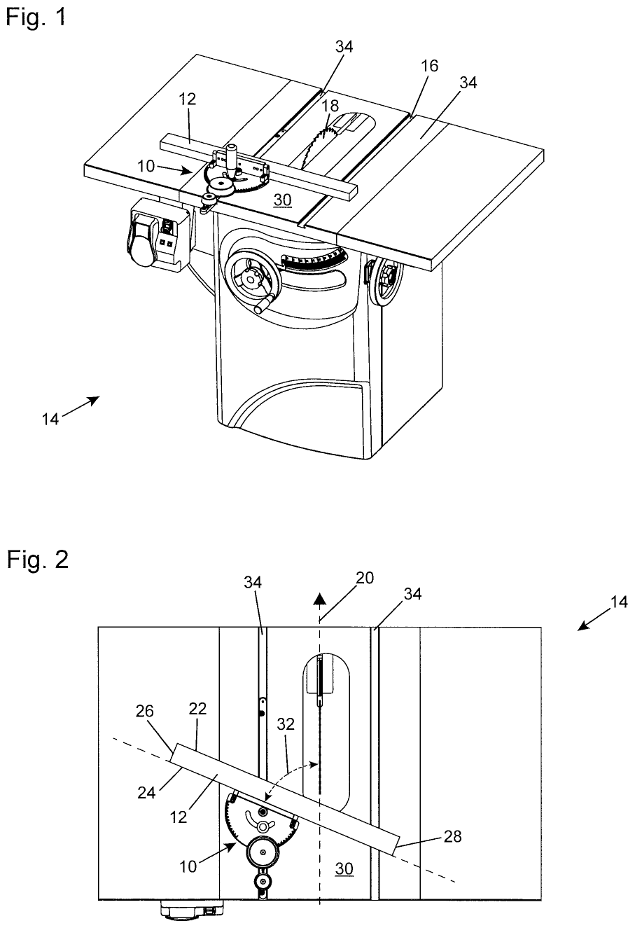

FIG. 1 shows an exemplary miter gauge 10 supporting a sample workpiece 12 on a common workpiece shaping tool in the form of a table saw, indicated generally at 14. As is typical for this type of workpiece shaping tool, table saw 14 has a generally flat workpiece support surface 16, which is commonly referred to as a table, and which is configured to support a workpiece as it is being moved relative to the table saw. A cutter in the form of a circular saw blade 18 is mounted to an internal table saw mechanism (not shown) which controls the position of the blade relative to the table and which includes a motor to drive the blade. The internal mechanism is controllable by a user or operator to raise, lower, and/or tilt the blade relative to the table. When performing cutting tasks, the operator controls the internal mechanism to raise the top of the blade to the desired cutting height above the table and sets the blade tilt or bevel angle of the blade relative to the table. Once the motor is turned on and begins driving the blade, the operator moves a workpiece into contact with the spinning blade which cuts the workpiece.

As shown in FIG. 2, table saw 14 has a feed direction 20 which is defined by the flat plane of saw blade 18. Sample workpiece 12 has a front edge 22, a rear edge 24, a left edge 26, and a right edge 28. The bottom surface of the workpiece (not shown) is in contact with the top surface 30 of table 16. After placing sample workpiece 12 on table 16 with the front edge spaced forward of the front of the blade, and with the left and right edges of the workpiece on either side of the blade, the operator can move or slide the workpiece toward the blade in a direction substantially parallel to the feed direction, thereby causing the workpiece to contact the spinning blade. As the workpiece continues moving, the blade will cut a slot through the front edge and into the workpiece between the left and right edges. If the rear edge of the workpiece is moved past the front edge of the blade, the workpiece will be cut into two pieces.

The line of cut through the workpiece is determined by the angle 32 between the rear edge of the workpiece and the feed direction as shown in FIG. 2. Angle 32 is commonly referred to as the “miter angle” and is typically expressed in angular degrees from a nominal 90 degree reference. For example, a zero degree miter angle means the rear edge of the workpiece is aligned at 90 degrees relative to the feed direction so that the workpiece is cut at a right angle relative to the rear edge. Similarly, a 30 degree miter angle means the rear edge of the workpiece is aligned at 60 degrees relative to the feed direction. To ensure the workpiece is cut at the desired location and along the desired line of cut, the operator must place the workpiece at the desired position on the table relative to the blade and at the desired miter angle relative to the feed direction, and then move the workpiece in the feed direction into contact with the blade. Exemplary miter gauge 10 enables an operator to accurately align the workpiece at the miter angle and to support the workpiece as it moves across the table.

As is well known to those of skill in the art, there are a variety of different types of workpiece shaping tools with which a miter gauge such as exemplary miter gauge 10 may be used. A few examples of such different types of workpiece shaping tools include band saws, radial arm saws, routers and router tables, bench sanders, tile cutters, etc. The different types of workpiece shaping tools typically include different types of cutters or other shaper components to perform a variety of different shaping operations on a variety of different workpiece materials. Thus, while the exemplary miter gauges described herein may be shown and described in use on a table saw, it should be understood that the exemplary miter gauges are not limited to use on a table saw. Instead, the exemplary miter gauges may be used on any of the variety of different types of workpiece shaping tools for which miter gauges are commonly used.

Table 14 includes channels 34 formed in the top surface of the table and running parallel with the feed direction. These channels are commonly referred to as “miter slots.” Table saw 14 is shown with two miter slots, one on either side of the blade, though some workpiece shaping tools have a single miter slot. Alternatively, a workpiece shaping tool might have more than two miter slots. Unlike workpiece shaping tools such as a table saws and band saws, some other types of workpiece shaping tools do not use miter slots because the workpiece is held stationary on the table while the cutter or shaper is moved into contact with the workpiece. Examples of these workpiece shaping tools include radial arm saws and some tile cutters. Nevertheless, it is often helpful when operating these workpiece shaping tools to align the workpiece at a miter angle relative to the feed direction in which the cutter or shaper moves. Therefore, for these workpiece shaping tools, the miter gauge can be configured to engage the tool so as to provide support and alignment to workpieces at a desired miter angle relative to the feed direction while the cutter or shaping moves into contact with the workpiece. As shown and described herein, exemplary miter gauge 10 is configured to engage either of miter slots 34, and to move along the miter slot in a path parallel to the feed direction while supporting the workpiece at the desired position and miter angle. However, it should be understood that the miter gauge may alternatively be configured to engage a different workpiece shaping tool in a different way which does involve moving the workpiece into contact with the cutter or shaper component.

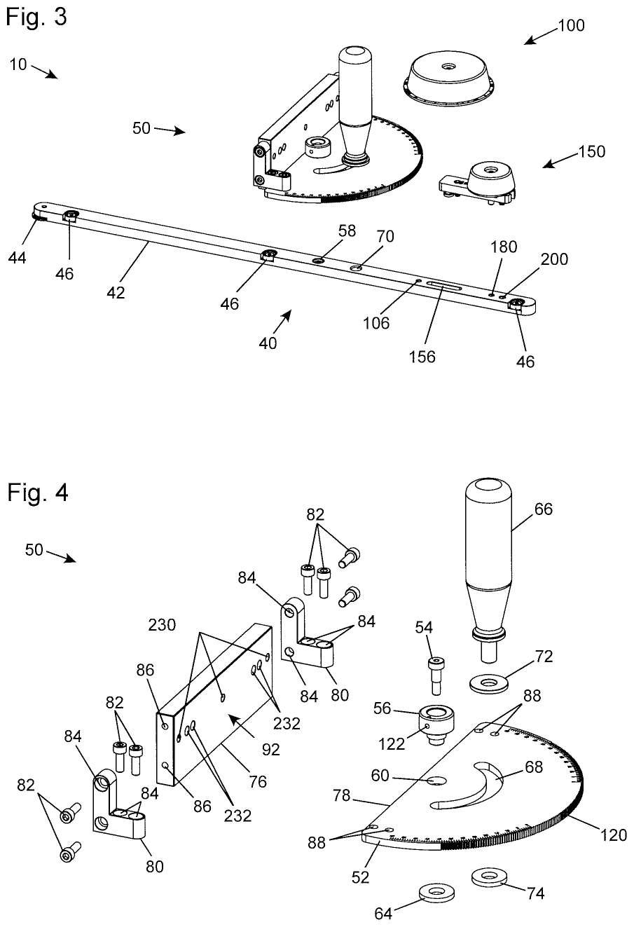

As shown in FIG. 3, exemplary miter gauge 10 includes four major subassemblies. An exemplary base subassembly, indicated generally at 40, includes an elongate bar 42 configured to fit within miter slots 34 and sit flush with, or just below, the top of table 16. A small retainer disk 44 is mounted to the bottom of one end of bar 42 and is sized to extend slightly outward of the sides of bar 42. Miter slots 34 have a generally upside-down T-shape in cross-section and disk 44 is configured to fit within with bottom portion of the T so as to prevent the bar from accidentally lifting out of the miter slot. A plurality of spacer disks 46 are mounted along the top portion of the bar and extend slightly outward of one side of the bar. The positions of disks 46 relative to the bar are adjustable and allow an operator to compensate for any clearance between the sides of the bar and the sides of the miter slots. As will be discussed below, bar 42 also includes various holes and channels for mounting the other subassemblies of miter gauge 10 to the base assembly.

While exemplary base subassembly 40 is configured as an elongate bar configured to slide within standard miter slots which are typically found on a variety of different types of workpiece shaping tools, it will be appreciated that base subassembly 40 may take alternative forms as needed which are configured to engage workpiece shaping tools which do not include standard miter slots. It should be understood that all such alternative forms which are configured to engage a workpiece shaping tool and maintain the miter gauge in a predetermined orientation relative to the feed direction are within the scope of this disclosure.

Exemplary miter gauge 10 also includes a workpiece alignment subassembly, indicated generally at 50, which is movably coupled to the base subassembly. Focusing now on FIGS. 3-5, exemplary workpiece alignment subassembly 50 includes a miter plate 52 which is pivotally coupled to bar 42 by a pivot screw 54 and pivot bushing 56. The head of the pivot screw sits within a top portion of the pivot bushing, while the bottom end of the pivot screw is threaded into a hole 58 in the bar. The middle portion of the pivot bushing fits within a matching hole 60 through the miter plate, while the lower portion of the pivot bushing sits within a circular recess 62 in the top of the bar. A washer 64 is positioned around the lower portion of the pivot bushing and serves as a low-friction interface between the bottom of the miter plate and the top of the bar. The height of the middle portion of the pivot bushing is slightly larger than the thickness of the miter plate, thereby ensuring the miter plate is not clamped when pivot bolt 54 is fully tightened. As a result, the miter plate is free to pivot around the pivot bushing relative to the bar.

A locking handle 66 passes through a slot 68 formed through the miter plate. Slot 68 is arcuate in shape and concentric with the middle section of pivot bushing 56. The lower end of the locking handle is threaded into a hole 70 in bar 42. An upper plastic washer 72 is positioned between the upper portion of the locking handle and the top of the miter plate. A lower washer 74 sits between the bottom of the miter plate and the top of the bar. By rotating the locking handle clockwise, an operator can clamp the miter plate between the washers and against the bar, thereby preventing the miter plate from pivoting. Conversely, by rotating the locking handle counter-clockwise, the operator can release the clamping pressure on the miter plate to allow the miter plate to pivot relative to the bar.

Each end of a workpiece support member 76 is mounted to the top of the miter plate adjacent a flat edge 78 of the miter plate by a pair of mounting brackets 80. Screws 82 pass through holes 84 formed in the mounting brackets and thread into mating holes 86 and 88 in the support member and miter plate, respectively. Holes 84 are slightly oversized relative to screws 82 so that the orientation and position of the workpiece support member can be finely adjusted relative to the miter plate. Exemplary workpiece support member 76 is generally shaped as a rectangular bar having a front surface 90 and a rear surface 92. The rear surface faces the locking handle while the front surface faces away from the locking handle. Front surface 90 is generally flat and functions as a workpiece support and alignment surface when the rear edge of a workpiece is held in contact with the front surface. The bottom 94 of workpiece support member 76 is typically positioned to rest on, or just slightly above, the table of the workpiece shaping tool.

Since the workpiece support member is rigidly fastened to the miter plate, the workpiece support member pivots relative to the bar when the miter plate pivots. As a result, the angle of the workpiece support surface relative to the bar, taken in a plane parallel to the top surface of the table, will change as the miter plate pivots. When the bar is placed in the miter slot, it is held parallel to the feed direction of the table saw. Thus, the angle of the workpiece support surface relative to the feed direction, taken in a plane parallel to the top of the table, changes when the miter plate pivots. This angle between the feed direction and the workpiece support surface is the miter angle of the workpiece support surface.

In view of the above discussion, the basic operation of miter gauge 10 can be understood. To cut a workpiece at a desired miter angle, an operator begins by rotating the locking handle to unclamp the miter plate. The operator then pivots the miter plate until the workpiece support surface is at the desired miter angle, and then rotates the locking handle to clamp the miter plate against further movement relative to the bar. Next, the operator holds the rear edge of a workpiece against the workpiece support surface to align the workpiece at the desired miter angle relative to the feed direction. The operator then slides the rear edge of the workpiece along the workpiece support surface until the workpiece is positioned so that the point on the front edge of the workpiece corresponding to the desired line of cut is directly in front of the blade. Finally, the operator holds the rear edge of the workpiece against the workpiece support surface and uses the locking handle to push both the miter gauge and workpiece in the feed direction toward the blade until the cut is completed.

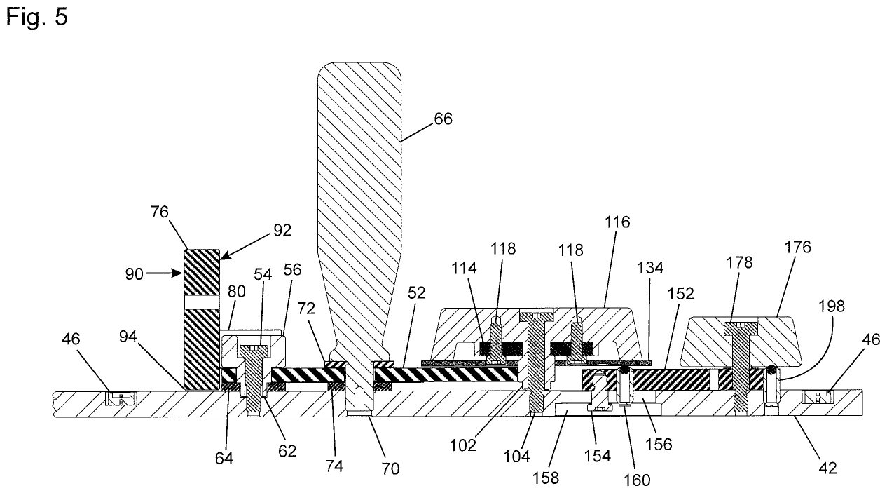

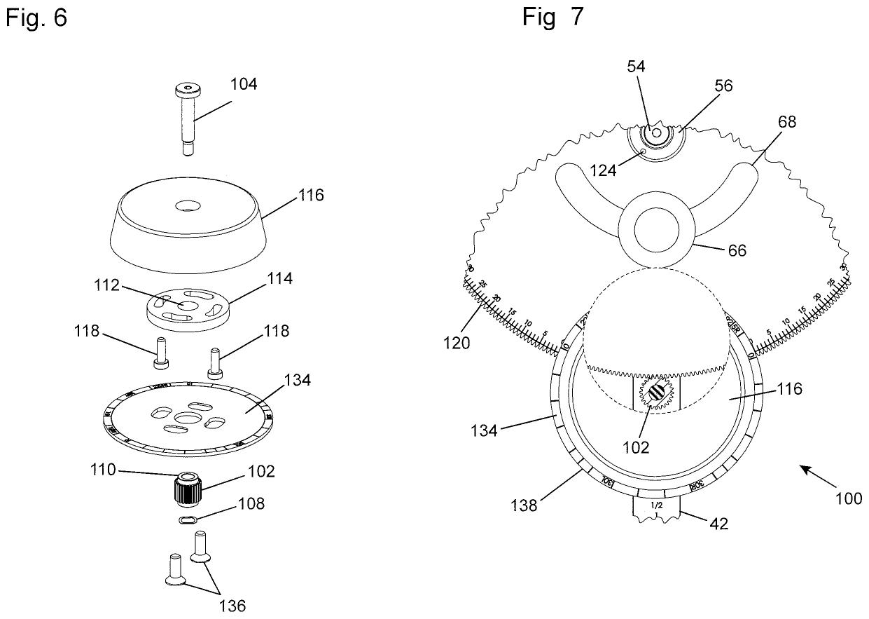

Most prior art miter gauges require the operator to manually pivot the miter plate to change the miter angle, typically by grasping and moving the workpiece support member. In contrast, exemplary miter gauge 10 includes a drive subassembly, indicated generally at 100 in FIG. 3, which is movably coupled to bar 42 and positioned to contact the workpiece alignment subassembly. When an operator moves the drive subassembly relative to the bar, the drive subassembly causes the miter plate to pivot about the pivot bushing, thereby changing the miter angle. As shown in FIGS. 5 and 6, the exemplary drive subassembly includes a pinon gear 102 which is rotationally coupled to bar 42 by a shoulder bolt 104 which passes through the central hub of the pinion gear and threads into a hole 106 in the bar (shown in FIG. 3). The bore of pinion gear 102 is sized to allow the pinion gear to rotate around the shoulder bolt. A plastic washer 108 is positioned between the bottom of the pinion gear hub and the top of the bar to bias the pinion gear upward slightly off the bar.

The upper end 110 of the pinion gear hub forms a cylindrical bushing with a smooth outer surface which is press-fitted into a hole 112 formed in the center of a circular torque transfer disk 114. Thus, the pinion gear is fastened to the transfer disk so as to rotate with the transfer disk. Alternatively, the upper end of the bushing and hole 112 may have one or more flat portions to reduce the possibility of the bushing rotating with the hole. In any event, the transfer disk is likewise fastened to an operative component 116 by screws 118 so that the transfer disk rotates when the operative component is rotated. In the exemplary embodiment, operative component 116 is in the form of a drive knob, but it will be appreciated that many alternative operative components are possible, including levers, handles, handwheels, etc., which may be gripped and moved by an operator to impart rotary motion to the pinion gear. In any case, drive knob 116 may be operated or turned by an operator to rotate the transfer disk and thereby the pinion gear.

A portion of the rearward facing edge 120 of miter plate 52 is formed as a sector gear which is concentric with hole 60 on the miter plate. As best seen in FIG. 7, pinion gear 102 is positioned on the bar so that the pinion gear teeth engage the matching gear teeth of sector gear 120. As a result, if the miter plate is not clamped to the bar, an operator can pivot the miter plate and change the miter angle by rotating knob 116. Furthermore, since the gear ratio between the pinion gear and the sector gear is 15:1, a moderate rotation of the drive knob results in a small pivot of the miter plate. This enables an operator to have a much finer control over the miter angle than by pivoting the miter plate manually. While the exemplary embodiment uses a gear ratio of 15:1 to provide fine control of the miter angle, it will be recognized by those of skill in the art that the pinion gear and/or sector gear may be configured to provide an almost infinite variety of different gear ratios as may be beneficial to a particular application. Therefore, it should be understood that all such gear ratios are within the scope of this disclosure.

To ensure smooth gear meshing with minimal pressure or slop between the teeth, it may be desirable to provide means to adjust the gear mesh. This would allow compensation for manufacturing tolerances and/or wear. While it will be recognized by those of skill in the art that there are various means and mechanisms for adjusting gear mesh, the exemplary embodiment includes a mechanism for adjusting the position of the miter plate, and thereby the sector gear, relative to the bar and the pinion gear. The middle portion of exemplary pivot bushing 56, which fits within hole 60 of the miter plate, is formed so that the outer circumference is somewhat eccentric relative to the lower portion of the pivot busing which sits within recess 62 on the bar. In other words, the center of the middle circumference of the pivot busing is somewhat offset from the center of the lower circumference. Therefore, by rotating the pivot bushing within recess 62, the center of the middle circumference moves relative to the bar. This causes hole 60 on the miter plate, and thus the miter plate itself, to move relative to the bar and the pinion gear.

To adjust the gear mesh, an operator simply rotates the pivot bushing until the sector gear is positioned correctly relative to the pinion gear. As can best be seen in FIG. 4, the upper portion of the pivot bushing includes a hole 122, which allows the operator to insert a small tool such as an Allen wrench into the hole and then move the tool to rotate the pivot bushing. Hole 122 also serves to indicate the orientation of the middle portion eccentricity, thereby allowing the operator to ensure it does not accidentally move from the desired orientation. Additionally, a small concavity 124 (shown in FIG. 7) or other marking may be formed on top of the pivot bushing to indicate the eccentricity orientation when hole 122 is not readily visible.

The rotatable pinion gear of exemplary drive subassembly 100 can be understood as forming a gear drive mechanism to pivot the workpiece alignment mechanism and thereby change the miter angle. However, it will be recognized by those of skill in the art that alternative embodiments of miter gauge 10 may include alternative drive mechanisms for changing the miter angle. As one example, a different gear or combination of gears may connect the knob and the workpiece alignment subassembly to pivot the miter plate. As another example, the pinion gear may be replaced with a roller constructed of a material such as elastomer which is configured to frictionally grip the miter plate so that torque on the knob is translated to pivotal movement of the miter plate relative to the bar. While a few examples are described herein, it will be understood that all such alternative embodiments are within the scope of this disclosure.

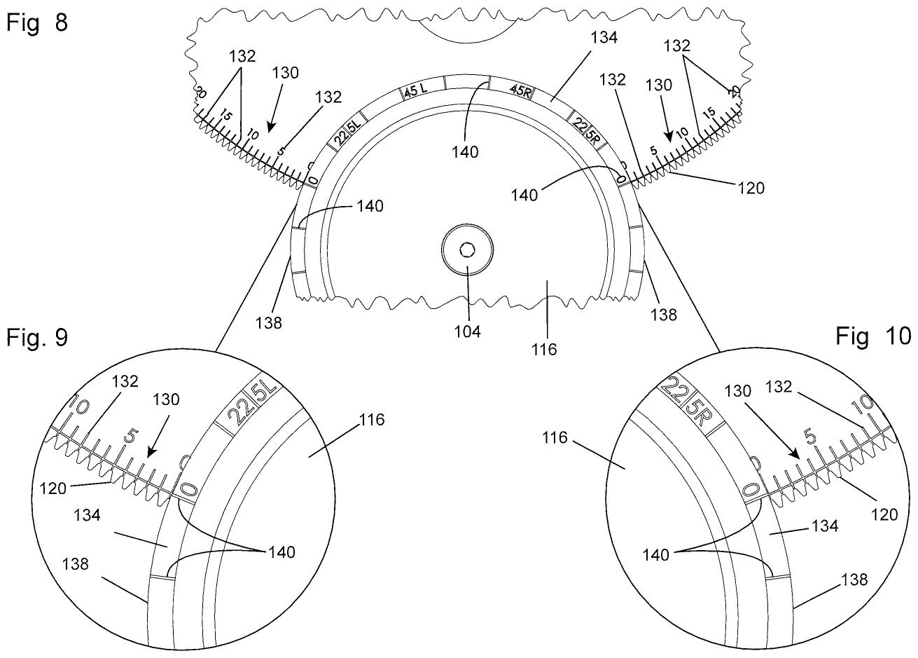

In addition to providing precise and fine control of the miter angle, exemplary miter gauge 10 is also configured to indicate the miter angle with both precision and fine detail. As shown in FIGS. 8-13, exemplary miter plate 52 includes two symmetric circular miter angle scales 130, printed or formed on the top of the miter plate adjacent the sector gear. The scale on the left side of the miter plate indicates the miter angle when the drive knob is rotated clockwise (as viewed from above), causing the miter plate to pivot counter-clockwise. Conversely, the scale on the right side of the miter plate indicates the miter angle when the knob is rotated counter-clockwise, causing the miter plate to pivot clockwise. The miter angle scales include an arcuate line delineated by discrete angle indicia or markings 132 which denote different miter angles. For exemplary miter scales 130, the indicia include lines which denote whole or one degree angular increments. Additionally, numeral indicia indicate each increment of five degrees to make reading the scale easier. Although the exemplary embodiment uses a combination of lines and numeral indicia to denote different miter angles, it will be recognized that alternative embodiments may use any type of indicia adapted to visually denote an angular reading to an operator, and that all such alternatives are within the scope of this disclosure. It should be noted that as used herein, the term “indicia” refers to both singular and plural indicating features.

Exemplary drive subassembly 100 includes a circular miter angle indicator disk or plate 134 which is mounted to the bottom surface of knob 116 by screws 136, as can be seen in FIGS. 5-6. The diameter of indicator plate 134 is somewhat larger than the diameter of the knob so that the circumferential edge 138 of the indicator plate extends outward of the knob. The indicator plate is positioned just slightly above the miter plate and angle scales so that edge 138 visually intersects one or both miter scales as seen from above. This visual intersection of edge 138 with one or both of the scales functions to visually indicate the miter angle.

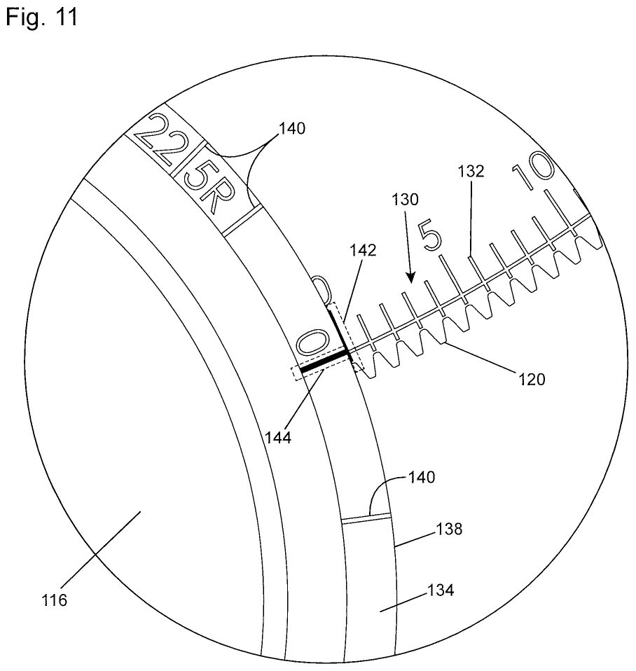

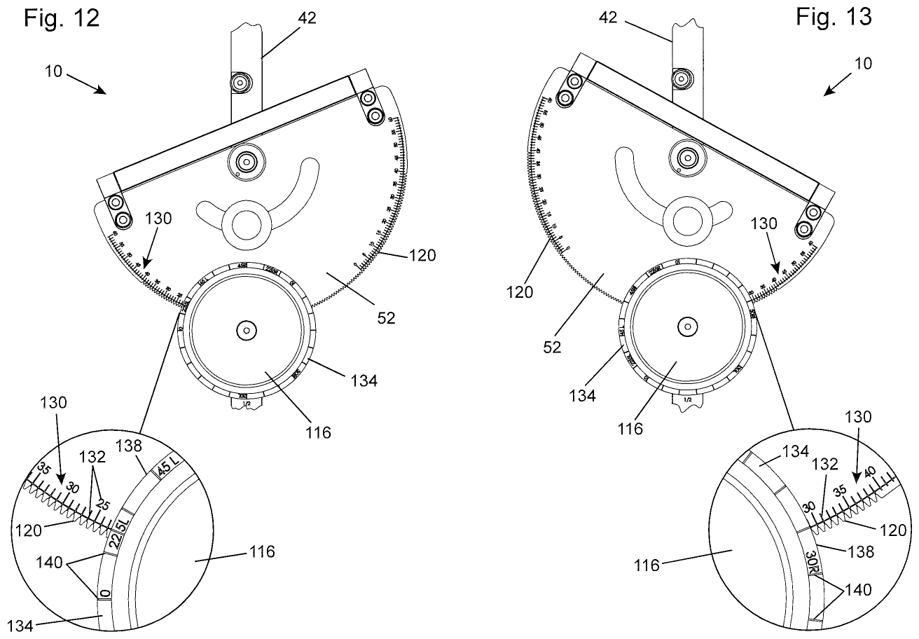

When the miter angle is at zero degrees, the edge of the indicator plate visually intersects both the left and right scales at the zero degree indicia for both scales, as shown in FIGS. 8-10. This situation indicates to the operator a reading of zero degrees for the miter angle. In the exemplary embodiment, both scales have a minimum of zero degrees. Thus, if the miter plate is pivoted counter-clockwise as shown in FIG. 12, the edge of the indicator plate no longer visually intersects the right miter scale, and the miter angle is indicated by the visual intersection of the edge with the left miter scale. Likewise, if the miter plate is pivoted clockwise as shown in FIG. 13, the edge of the indicator plate no longer visually intersects the left miter scale, and the miter angle is indicated by the visual intersection of the edge with the right miter scale. As a result, the operator can read the miter angle regardless of which direction the miter plate is pivoted by the visual intersection of edge 138 with one or both miter scales.

While the visual intersection of edge 138 with the miter scales allows an operator to see the current miter angle easily and quickly, it may be difficult to determine if the miter angle is at a precise angular setting such as 1.0 or 2.0 degrees. For example, it might be relatively easy to see that the miter angle is not precisely at 2.0 degrees if the actual miter angle is 1.5 degrees, and the edge is visually intersecting one of the scales halfway between the 1 and 2 degree indicia. However, as the miter plate pivots and the 2 degree indicia approaches the edge, it might be more difficult to determine precisely when the miter angle is at 2.0 degrees rather than 1.9 degrees, 2.2 degrees, or etc. Error in visually determining when the edge intersects the scale may be caused by a variety of factors including debris, low light, viewing angle, visual acuity, etc. In other words, the visual intersection of edge 138 with scale 130 may enable a precision of about 0.25 degrees when reading the miter angle depending on the conditions and the care with which an operator reads the scale.

To improve the precision with which an operator can determine or read the miter angle, exemplary indicator plate 134 includes a plurality of discrete indicator indicia or markings 140 which are formed or printed on the top surface of indicator plate 134 and adjacent edge 138. The exemplary indicator indicia include radial lines with a central axis that is concentric with the indicator plate, as well as numerals which correspond to several of the more frequently used miter angles. Since indicator indicia 140 lie generally along lines which are radial from the center of the indicator plate, each indicia visually appears to align with the arcuate portion of scale 130 when that indicia is positioned to visually intersect the scale.

Like the exemplary angular indicia on miter plate 52, most of the exemplary indicator indicia on indicator plate 134 correspond to distinct one degree angular increments. Additionally, there are specific indicator indicia that correspond to the frequently used 22.5 degree miter angle on each miter scale. It will be appreciated that different numbers and spacings of indicator indicia may be used in alternative embodiments. In any case, the exemplary gear ratio between the pinion gear and the sector gear results in a greater spatial separation between the one degree indicator indicia on the indicator plate than the one degree angle indicia on the miter plate. In other words, the 15:1 gear ratio means the indicator plate must rotate 15 degrees for a corresponding one degree change in the miter angle. This allows an operator to visually perceive small differences or changes in the miter angle. Thus, if a particular angle indicia visually appears to be somewhat close to edge 138, but none of the indicator indicia are aligned with the scale, then an operator knows that the miter angle is not precisely equal to the angle denoted by the particular angle indicia.

FIG. 11 shows an enlarged view of the region where the indicator plate visually intersects the right miter scale. The angle scale and the indicator plate as illustrated in FIG. 11 show a miter angle of 0.0 degrees because the angle indicia which denotes zero degrees is directly adjacent and visually aligned with edge 138, while an indicator indicia (designated as a zero indicia by the numeral “0”) is directly adjacent and visually aligned with miter scale 130.

Another way to understand how the exemplary miter scale is read or interpreted is to focus on the location or area designated by the dash line box 142 in FIG. 11, which is also referred to herein as the “operative location” of the angle indicia for the right miter scale. This operative location is the area or space which is directly adjacent the edge of the indicator plate. The operative location is stationary relative to bar 42 such that it does not move as the miter plate pivots or the indicator plate rotates. As a result, when the miter plate pivots in a clockwise direction from zero degrees to the maximum miter angle permitted, each angle indicia of the right miter scale will consecutively enter, be present within, and then pass through or out of operative location 142. Furthermore, when a particular angle indicia occupies or is present within operative location 142, then that particular indicia may be thought of as being “operative” so that the angle denoted by that particular indicia corresponds to the current miter angle. It will be understood that a similar operative location exists for the left miter scale which is adjacent the area where the indicator plate visually intersects the left miter scale.

Similarly, the dash line box 144 designates an “operative location” of the indicator indicia which is directly adjacent the miter scale and visually aligned with the arcuate portion of the scale. Operative location 144 is also stationary relative to the bar such that it does not move as the miter plate pivots or the indicator plate rotates. As the knob and indicator are rotated through 360 degrees, each indicator indicia will consecutively enter, be present within, and then pass through or out of operative location 144. Furthermore, when a particular indicator indicia occupies or is present within operative location 144, then that particular indicia may be thought of as being “operative” so that the angle denoted by that particular indicia corresponds to the current miter angle. As with the operative location for the angle indicia of the left miter scale, a similar operative location exists for the indicator indicia which is adjacent the area where the indicator plate visually intersects the left miter scale.

From the above description, the precision with which an operator can read the miter angle of exemplary miter gauge 10 can be understood. When a particular angle indicia is present within operative location 142 for angle indicia simultaneously with the presence of an indicator indicia within operative location 144 for indicator indicia, then the miter angle is substantially equal to the angle denoted by the particular angle indicia which is present at operative location 142. In FIG. 11, the angle indicia which denotes zero degrees is present within operative location 142 while an indicator indicia (specifically the “zero” indicator indicia) is present within operative location 144. Thus, the miter angle shown in FIG. 11 is substantially equal to 0.0 degrees.

However, if knob 116 were rotated counter-clockwise by five degrees, then the zero indicator indicia would move so that is visually out of operative location 144. At the same time, the miter plate would pivot clockwise ⅓ degree which would cause the zero angle indicia to move slightly so that it is visually out of operative location 142, or at least partially out of operative location 142. Regardless of whether the angle indicia is completely out of operative location 142, the indicator indicia will be clearly out of operative location 144, thereby indicating to the operator that the miter angle is not precisely at 0.0 degrees. Moreover, the positions of adjacent indicator indicia relative to operative location 144 allow an operator to visually estimate the fractional degree of the miter angle. For example, if two adjacent indicator indicia are substantially equally spaced from operative location 144, the operator can estimate that the miter angle is at approximately 0.5 degrees between the two angle indicia nearest operative location 142. Similarly, if the operator then rotates the knob counter-clockwise so that the indicia which is clockwise of operative location 144 moves half the distance toward the operative location, then the operator can estimate that the miter angle is at approximately 0.75 degrees between the two angle indicia nearest operative location 142.

As can be seen in FIG. 11, when an angle indicia is present within operative location 142 simultaneously with the presence of an indicator indicia within operative location 144, the respective angle indicia and indicator indicia are closely adjacent one another and the indicator indicia appears to visually align with the angle indicia where joins the arcuate line of the miter scale. Even a relatively small rotation of knob 116 will cause movement of the indicator indicia which is easily visible to an operator, thereby causing the two indicia to no longer appear visually aligned. Thus, small fractional degree changes in the miter angle from a whole number are readily apparent. While operative locations 142 and 144 are adjacent one another in the exemplary embodiment, in alternative embodiments location 144 may be positioned spaced apart from location 142 such that indicia within each location may not appear visually aligned. Nevertheless, the simultaneous presence of angle and indicator indicia in their respective operative locations would still indicate the miter angle is substantially equal to the angle value denoted by the angle indicia.

FIGS. 12 and 13 show further examples of how the angle and indicator indicia combine to provide a precise reading of the miter angle. Turning first to FIG. 12, the miter plate is shown pivoted counter-clockwise until the miter angle is at 22.5 degrees. The edge of the indicator plate visually intersects the left miter scale between the angle indicia which denote 22 degrees and 23 degrees. In other words, neither angle indicia is wholly within the operative location for angle indicia on the left miter scale. However, the indicator indicia which is labelled “22.5” is within the operative location for indicator indicia adjacent the left miter scale. Moreover, the 22.5 indicator indicia is visually aligned with the arcuate portion of the left miter scale, which indicates the miter angle is substantially equal to 22.5 degrees. On the other hand, the miter plate of FIG. 13 has been pivoted clockwise until the angle indicia which denotes 29 degrees is within the operative location for angle indicia on the right miter scale. Additionally, an indicator indicia is within the operative location for indicator indicia adjacent the right miter scale, thereby causing the indicator indicia to be visually aligned with the arcuate portion of the right miter scale. This signifies that the miter angle is substantially equal to 29.0 degrees.

As noted above, exemplary indicator plate 134 includes 24 equally-spaced indicator indicia to correspond to each 15 degree angular increment of the full circular shape of the indicator plate. Since the exemplary gear ratio between the pinion and sector gears is 15:1, each indicator indicia corresponds to a 1 degree angular increment of the miter angle. Additionally, there are two indicator indicia which correspond to the 22.5 degree miter angle for both the right and left miter scales. However, alternative embodiments of indicator plate 134 may include a higher number of indicator indicia, thereby providing increased resolution for displaying fractional miter angles. As just one example, an alternative indicator plate might have 96 equally-spaced indicator indicia, such that each indicator indicia corresponds to a 3.75 degree angular increment of the full circular shape of the indicator plate, and a 0.25 degree angular increment of the miter angle. Those of skill in the art will recognize that many different alternatives are possible to achieve the desired angular resolution, and that all such variations are within the scope of this disclosure.

Another way to think of the interaction between the angle indicia of the exemplary miter scale and the indicator indicia of the exemplary indicator plate, is as two arcuate scales which are ruled with discrete indicia, and which move relative to each other such that alignment between an indicia of one scale with an indicia of another scale indicates that the miter angle is substantially equal to the angle denoted by at least one of the indicia. As discussed above, when knob 116 is rotated, the indicator plate rotates with the knob. Additionally, the gear drive connected to the knob causes the miter plate and miter scale to rotate. Thus, the miter plate and the indicator plate move relative to each other as well as relative to the bar. When the knob is being rotated, the indicia of both scales pass adjacent one another as the miter angle changes in predetermined angular increments, periodically sequencing between alignment and non-alignment. In other words, the indicia of the miter plate and indicator plate form dual scales that visually intersect as they move past each other, so that consecutive indicia from one scale move into and out of alignment with consecutive indicia of the other scale. The alignment of any two indicia indicates the miter angle is substantially equal to the angular value denoted by at least one of the indicia.

In addition to the miter scales and indicator plate which provide visual indication of the miter angle, exemplary miter gauge 10 also includes a detent feedback mechanism or subassembly which is indicated generally at 150 in FIG. 3. Exemplary detent feed mechanism 150 is configured to generate a distinct tactile stimulus each time the miter angle changes by a selected angular increment. The tactile stimuli generated by the detent feedback mechanism are transmitted to drive knob 116 so that an operator can sense the stimuli as the operator rotates the knob. Thus, an operator receives tactile feedback to indicate when the miter angle has changed by a selected angular increment. Moreover, as will be described below, exemplary detent feedback mechanism 150 enables an operator to select the angular increments for which tactile stimuli are generated.

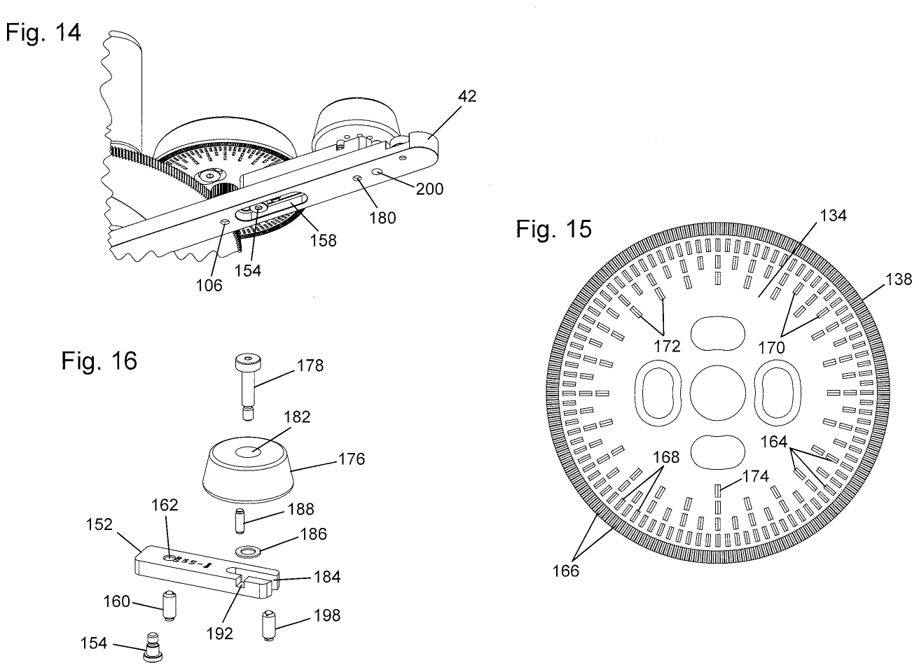

As shown in FIGS. 5 and 14-20, exemplary detent feedback mechanism 150 includes a rectangular detent selector carriage 152, the front end of which is coupled to bar 42 by a shoulder bolt 154. As best seen in the cross-sectional view of FIG. 5, the threaded portion of shoulder bolt 154 is threaded into a hole in the bottom of carriage 152, while the shank of the shoulder bolt passes through a slot 156 formed in bar 42. The head of the shoulder bolt is received within a recess 158 formed in the bottom of the bar and surrounding slot 156. The length of the bolt shank is slightly larger than the thickness of slot 156 so that the shoulder bolt is free to slide within the slot. As a result, carriage 152 is free to slide over the top of bar 42.

A spring ball plunger 160 is threaded into a hole 162 near the front end of carriage 152 such that the ball of plunger 160 protrudes above the top of the carriage to contact the bottom surface of indicator plate 134. The bottom surface of the indicator plate is formed with multiple small depressions or concavities 164. When an operator rotates knob 116 to adjust the miter angle, the indicator plate also rotates, causing the concavities on the bottom of the indicator plate to pass above spring ball plunger 160. If a particular concavity passes directly over the ball of plunger 160, the ball will be pushed upward by the spring into the concavity. If the indicator continues to rotate, the ball will by pushed downward by the indicator plate as the concavity moves away from the ball. This upward and downward movement of the ball into and out of concavities 164 on the indicator plate generates mechanical impulse forces on the indicator plate. These impulse forces are transmitted to knob 116 as tactile stimuli which can be perceived or felt by an operator turning the knob.

As best seen in FIG. 15, exemplary indicator plate 134 includes multiple sets of concavities which are arranged in concentric rings at varying radial distances from the center of the indicator plate. Furthermore, the angular spacing between the concavities varies among the different sets. In the outermost set 166, the concavities are spaced at angular increments of 1.5 degrees. In other words, a concavity is placed at every 1.5 degree increment around the ring formed by set 166. Thus, there are 240 concavities over the entire 360 degree circumference of set 166. Similarly, set 168 which is just inside set 166, is composed of concavities which are spaced at angular increments of 3.75 degrees, set 170 is composed of concavities which are spaced at angular increments of 7.5 degrees, and set 172 is composed of concavities which are spaced at angular increments of 15 degrees.

Since the gear ratio between the pinion and sector gears is 15:1, the miter plate will pivot by 1/15^{th} of a degree for each one degree rotation of the indicator plate. As a result, set 166 corresponds to 0.1 degree of pivot in the miter plate. In other words, the angular distance between adjacent concavities in set 166 represents a 1/10^{th} degree change in the miter angle. For this reason, set 160 is also referred to herein as the “ 1/10^{th} degree set.” Likewise, set 168 represents a 0.25 degree change in the miter angle and is also referred to herein as the “¼^{th} degree set.” Set 170 represents a 0.5 degree change in the miter angle and is also referred to herein as the “½ degree set.” Finally, set 172 represents a 1 degree change in the miter angle and is also referred to herein as the “1 degree set.”

When spring ball plunger 160 is positioned directly below one of the sets of concavities, the ball will consecutively engage each adjacent concavity as the indicator plate rotates. Each engagement of a concavity will generate a tactile stimulus which is perceptible at the knob. For example, if the spring ball plunger is positioned directly below 1/10^{th} degree set 166 when the indicator plate is rotated, a distinct tactile stimulus will be generated for each 1/10^{th} degree change in the miter angle. Similarly, if the spring ball plunger is positioned directly below ½ degree set 170 when the indicator plate is rotated, a distinct tactile stimulus will be generated for each ½ degree change in the miter angle. In other words, a distinct tactile stimulus will be generated in response to each increment of angular change in the miter angle which corresponds to the set of concavities under which the spring ball plunger is positioned.

As shown in FIG. 15, exemplary indicator plate includes one additional set 174 having a single concavity. Set 174 allows an operator to essentially disengage the detent feedback mechanism and rotate the knob freely without continuous tactile stimuli. Set 174 is also referred to herein as the “free set.” The single concavity of set 174 corresponds to a miter angle of zero degrees, thereby allowing the operator to easily return the miter angle to zero degrees when needed. As a result of the 15:1 gear ratio, the single concavity will pass over the spring ball plunger with each full rotation of the indicator plate, thereby generating discrete stimuli only at 24 degree increments of the miter angle.

The concavities formed in the bottom of the indicator plate may also be thought of as detent structures and the spring ball plunger may be thought of as a tactile stimulus generator. In combination, the detent structures and tactile stimulus generator form a portion of detent feedback mechanism 150. While the exemplary embodiment includes sets of detent structure corresponding to increments of 1/10^{th} degree, ¼^{th} degree, ½ degree, and 1 degree, it will be appreciated that alternative embodiments may include different quantities of sets, and/or sets configured to result in tactile stimuli at different angular increments.

Furthermore, while the detent structures of the exemplary embodiment are formed as concavities, it will be appreciated by those of skill in the art that the detent structures may alternatively take other forms including convex ribs, domes, or other shapes which extend downward somewhat from the bottom surface of the indicator plate to be engaged by the ball of the spring ball plunger. Similarly, the tactile stimulus generator may take a variety of alternative forms including a flexible member that moves over the detent structures and generates tactile stimuli as the flexible member alternately engages and then moves past the detent structures. As a further alternative, the detent structures could be formed as flexible protrusions, either attached to, or integral with the indicator plate, which extend downward from the bottom of the indicator plate to engage the tactile stimulus generator. In this latter alternative embodiment, the tactile stimulus generator could be a spring-biased mechanism such as a spring ball plunger, or it could be a rigid component that causes the detent structures to flex as they contact and then pass by the component. In any event, it should be recognized that all such alternatives are within the scope of this disclosure.

As discussed above, the detent feedback mechanism will generate a distinct tactile stimuli each time the miter angle changes by a selected angular increment. Therefore, to select a desired angular increment, an operator need only position the spring ball plunger directly below the set of concavities which correspond the desired increment. Since the spring ball plunger is mounted to carriage 152, moving the carriage in a radial direction toward or away from the center of the indicator plate causes the spring ball plunger to move in a likewise direction. Thus, by sliding the carriage over bar 42, an operator can select the desired set of detent structures and corresponding angular increments.

In the exemplary embodiment, an operator can move carriage 152 by turning a detent selector knob 176. The detent selector knob is rotationally mounted to bar 42 by a shoulder bolt 178 which threads into a hole 180 in the bar. The shank of bolt 178 passes through a hole 182 in the center of knob 176 and then through a channel 184 formed in the rear end of carriage 152. The diameter of hole 182 is slightly larger than the diameter of the bolt shank, and the thickness of the knob is slightly less than the length of the bolt shank. As a result, the knob is able to rotate freely about the shoulder bolt. A washer 186 is positioned around the bolt shank and between knob 176 and carriage 152. The combination of the bolt shank within channel 184 and washer 186 ensures the carriage is held against the top of bar 42 while sliding parallel to the elongate axis of the bar.

The top of a guide pin 188 is pressed into a hole 190 on the bottom of knob 176 at a location which is spaced to the left of the rotational axis of the knob. Thus, guide pin 184 moves forward when the detent selector knob is rotated clockwise, and backward when the knob is rotated counter-clockwise. The bottom of the guide pin extends into a notch 192 formed in the top of carriage 152. When the detent selector knob is rotated clockwise, pin 188 moves forward and pushes the carriage forward. Conversely, when the detent selector knob is rotated counter-clockwise, pin 188 moves backward and pulls the carriage backward. As a result, when the detent selector knob is rotated, spring ball plunger 160 moves either forward or backward with the carriage. In other words, an operator may select the desired set of detent structures by rotating the detent selector knob. For example, to cause the detent feedback mechanism to generate tactile stimuli for each ½ degree change in the miter angle, an operator rotates the detent selector knob until the spring ball is positioned directly under set 170.

To assist an operator in correctly positioning spring ball plunger 160, the top surface of carriage 152 includes numerical detent indicia 194 which correspond to the sets of detent structures on the bottom of the indicator plate. Thus, for example, when the “½ degree” indicia is positioned directly immediately beyond the perimeter of the indicator plate, this indicates to the operator that the spring ball plunger is positioned to engage the ½ degree set of detent structures. Similar indicia perform the same function for the other sets of detent structures.

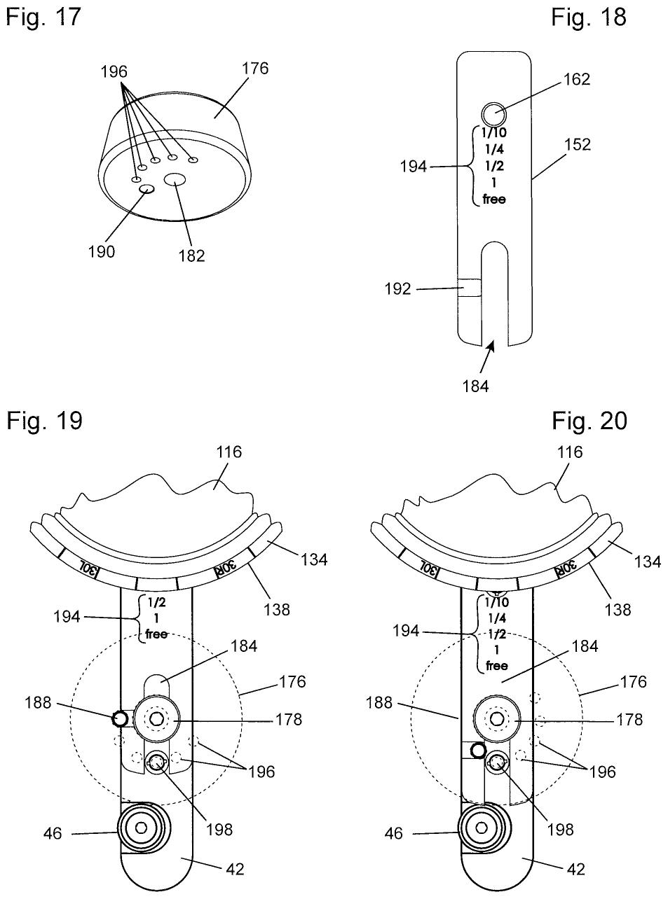

Additionally, exemplary detent feedback mechanism 150 includes a further detent mechanism which is configured to generate tactile stimuli at the detent selector knob when spring ball plunger 160 is correctly positioned to engage one of the sets of detent structures on the indicator plate. As can best be seen in FIG. 17, the bottom surface of detent selector knob 176 includes multiple detent structures 196 in the form of semi-spherical concavities which are spaced along a circular arc that is concentric with the center of the knob. The threaded end of a second spring ball plunger 198 is mounted in a hole 200 in the miter bar. The ball of the spring ball plunger is positioned to contact the bottom surface of the detent selector knob at a position that lies along the arc of detent structures 196. Thus, when the detent selector knob is rotated the spring ball consecutively engages and then moves past each detent structure, thereby generating a tactile stimulus at the detent selector knob each time the spring ball engages a detent structure. The detent structures are positioned on knob 176 so that the spring ball engages a detent structure whenever the carriage is correctly positioned to select the desired set of detent structures on the indicator plate. While the tactile stimulus generated by spring ball 198 at knob 176 indicates to an operator that spring ball plunger 160 is precisely positioned under one of the sets of detent structures on indicator plate 134, it is detent indicia 194 that indicate which of the sets will be engaged.

The operation of the detent selector mechanism is shown in FIGS. 19-20. Beginning with FIG. 19, the detent selector knob has been rotated until guide pin 188 is directly to the left of the rotational axis of the knob. In other words, the guide pin is at a middle point between fully forward and fully backward. Spring ball 198 is engaged with the middle one of the detent structures 196 on the bottom of the knob, and the “½ degree” detent indicia on top of the carriage is positioned just outside the perimeter of the indicator plate. Although not shown, spring ball plunger 160 is positioned to engage the ½ degree set of concavities on the bottom of the indicator plate.

Now turning to FIG. 20, the detent selector knob has been rotated counter-clockwise, causing guide pin 188 to pull the carriage backward from its position in FIG. 19. Spring ball 198 now engages one of detent structures 196, and the “ 1/10^{th} degree” detent indicia on top of the carriage is positioned just outside the perimeter of the indicator plate. Although not shown, spring ball plunger 160 is positioned to engage the 1/10^{th} degree set of concavities on the bottom of the indicator plate. Thus, exemplary detent feedback mechanism 150 provides both visual indicators and tactile stimuli when an operator turns the detent selector knob to select the miter angle increments which produce tactile stimuli at drive knob 116.

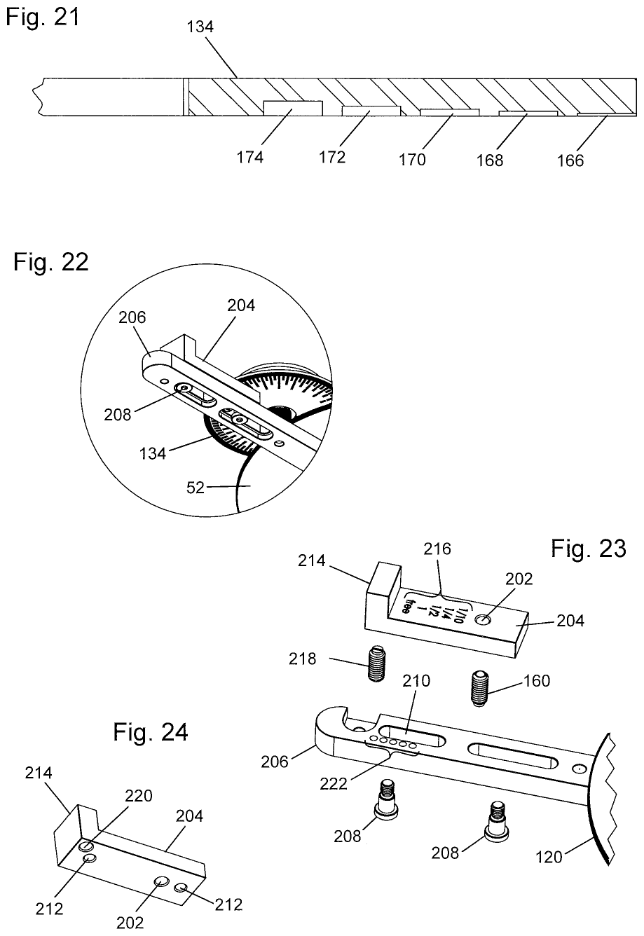

While one exemplary detent feedback mechanism has been described above for producing tactile stimuli upon each selected increment of angular change in the miter angle, it will be appreciated by those of skill in the art that many alternatives and modifications are possible within the scope of this disclosure. As one alternative example, the detent feedback mechanism may be configured to produce tactile stimuli of differing magnitudes or intensities depending on the angular increment. FIG. 21 shows an alternative indicator plate in which each set of concavities is formed at different depths. Thus, the concavities within 1/10^{th} degree set 166 are formed at the shallowest depth, with the concavities within ¼^{th} degree set 168 being formed slightly deeper. This progression in depth continues until the single concavity of free set 174, which is formed as the deepest concavity and deeper than the concavities of any other sets. The magnitude or intensity of the tactile stimulus which is generated when the spring ball engages a concavity, will increase with increasing concavity depth. Thus, for example, the tactile stimuli generated when the 10th degree set is selected will be lower in magnitude than the tactile stimuli generated when the ½ degree set is selected. In other words, the magnitude of the tactile stimuli will increase as the angular increment which triggers the stimuli increases.

Since variations in the magnitudes of the tactile stimuli are perceptible by an operator, alternative detent feedback mechanisms may be configured with all detent structures in a single set, while still indicating to an operator the increment of angular change in the miter angle. For example, a single set of detent structures may include shallow concavities at ¼ and ¾ degree fractional miter angles, moderate concavities at ½ degree fractional miter angles, and the deepest concavities at whole degree angles. In such an alternative detent feedback mechanism, it may not be necessary to move the tactile stimulus generator among different sets of detent structures. Alternatively, such a multi-depth concavity set may be provided in addition to constant depth sets of concavities as described above. It will be recognized by those of skill in the art that all such alternatives and combinations thereof are within the scope of this disclosure.

Additionally, while exemplary detent feedback mechanism 150 includes a rotary knob for selecting among different sets of detent structures, many alternative mechanisms for selecting the desired set are possible. As just one example, FIGS. 22-24 show an alternative embodiment in which an operator applies linear rather than rotary force to select a detent set. In this alternative embodiment, spring ball plunger 160 is threaded into a hole 202 near the front end of an alternative carriage 204 which is mounted to slide along the top of an alternative bar 206 by two shoulder bolts 208. The shoulder bolts pass through channels 210 in bar 206 and thread into holes 212 the bottom of carriage 204. The shanks of the shoulder bolts are sized to allow the carriage to slide freely relative to bar 206, while constraining the carriage to move parallel to the elongate axis of the bar. The rear end of carriage 204 includes a handle portion 214 with which an operator can push or pull the carriage in a linear direction to move the spring ball plunger under the indicator plate to the selected set of detent structures.

Alternative carriage 204 includes detent indicia 216 similar to detent indicia 194. Additionally, a second spring ball plunger 218 is threaded into a hole 220 on the bottom of carriage 204 to engage detent structures 222 formed in the top of bar 206. The detent structures are positioned and spaced such that spring ball 218 engages one of the detent structures whenever carriage 204 is positioned to locate spring ball plunger 160 to engage one of the sets of concavities on the indicator plate. Engagement of a detent structure by spring ball 218 will generate a tactile stimulus at handle 214 which is perceptible by an operator gripping the handle. When spring ball 218 is engaged with one of detent structures, detent indicia 216 will indicate which set of detent structures on indicator plate 134 has been selected. Thus, to select a desired increment of change in the miter angle which triggers a tactile stimulus at drive knob 116, an operator simply slides carriage 204 over bar 206 until the appropriate detent indicia on carriage 204 is just beyond the perimeter of the indicator plate and the operator senses a tactile stimulus on handle 214.

As described above, exemplary miter gauge 10 enables an operator to precisely align a workpiece at a desired miter angle with ease and precision. Miter gauge 10 provides both visual and tactile feedback to an operator that the miter angle support surface is aligned at the desired miter angle relative to the feed direction. As also described above, various alternative configurations and combinations are possible which provide either the same or somewhat different performance as may be beneficial for particular shaping operations, workpieces, and/or workpiece shaping tools. Nevertheless, all such alternatives and combinations are included within the scope of this disclosure.

While workpiece support member 76 provides a workpiece support surface which is sufficient for a variety of shaping operations and workpiece sizes, some operators find it easier to support and align larger workpieces with a larger workpiece support surface. One option for increasing the size of the workpiece support surface is to attach a flat piece of wood or other material to the workpiece support member by passing screws or bolts through the wood and into the threaded mounting holes 230 (shown in FIG. 4) in the workpiece support member. By selecting a piece of wood that is larger than the workpiece support member, an operator can increase the size of the workpiece support surface. However, it can be difficult to obtain wood or similar materials in pieces which are both relatively large and substantially flat.

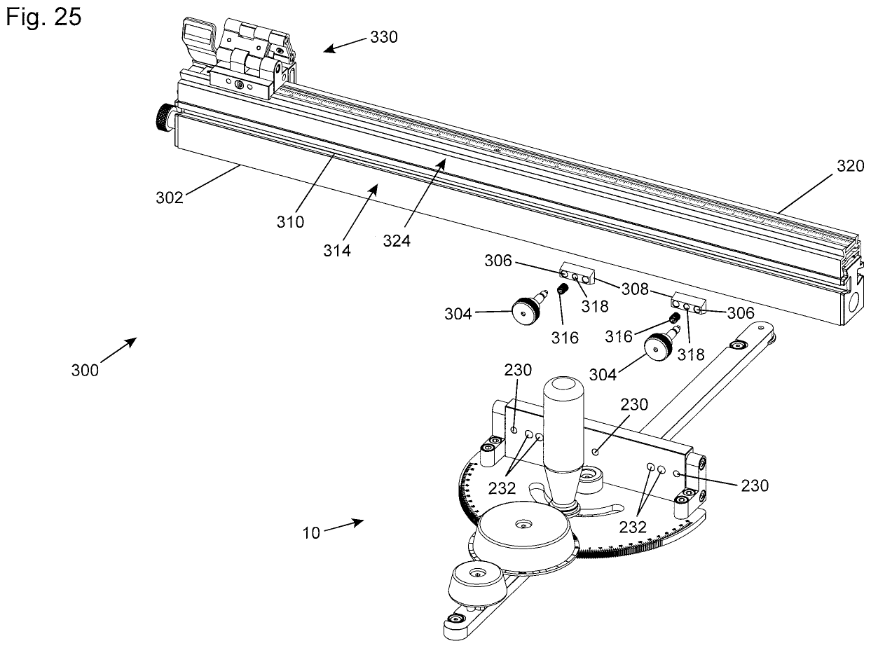

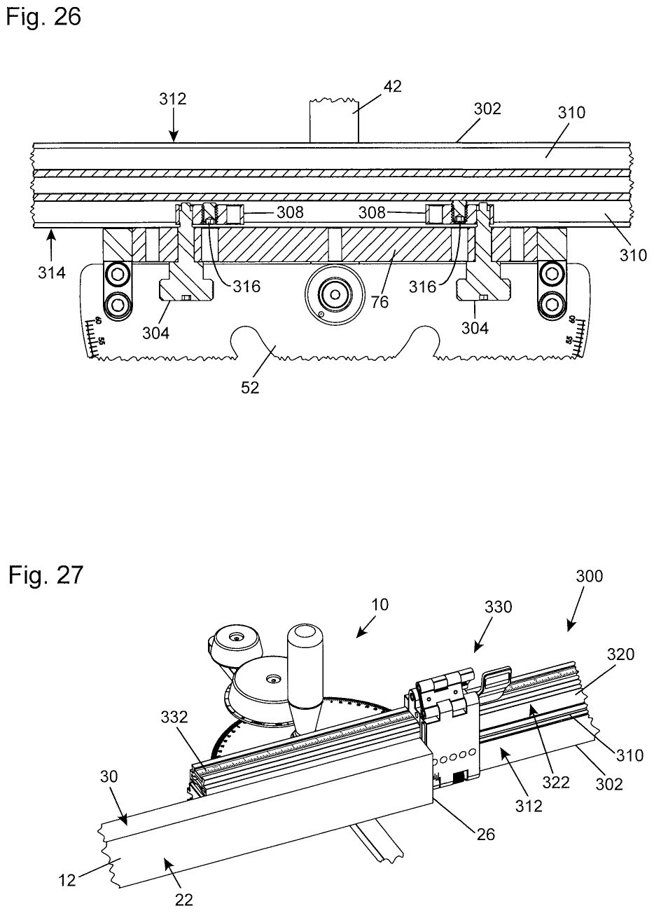

An improved option for increasing the size of the workpiece support surface is shown in FIGS. 25-27. Exemplary miter fence assembly, indicated generally at 300, includes an elongate lower fence rail 302 which is attachable to exemplary miter gauge 10 by thumb screws 304. The thumb screws are sized to pass through non-threaded holes 232 in the workpiece support member, and then tighten into threaded holes 306 in wedge blocks 308. The wedge blocks fit and slide within channels 310 formed in the front and rear faces 312 and 314, respectively, of lower rail 302. Set screws 316 thread into central holes 318 in the wedge blocks. Once an operator positions a wedge block in the desired location along the channel, the set screw can be tightened until it presses against the lower rail and frictionally locks the wedge block in place. Thus, the position of an exemplary wedge block along the length of the lower rail can be fixed or locked within the channel independently of whether the fence assembly is mounted to the miter gauge.

Exemplary lower rail 302 is formed by aluminum extrusion, though alternative materials and manufacturing methods may be used within the scope of this disclosure. Front surface 312 is substantially parallel to rear surface 314 so that, when the rear surface is placed against the front surface of the workpiece support member, the front surface of the lower rail will be parallel to the front surface of the workpiece support member. Fence assembly 300 also includes an elongate upper rail 320 which is configured to engage the top of lower rail 302. Like the lower rail, the exemplary upper rail is formed by aluminum extrusion and the two rails are shaped to create a dovetail joint at the interface between the rails. The dovetail interface allows the upper rail to slide along the top of the lower rail parallel to the elongate axes of the two rails. The width of the upper rail is equal to the width of the lower rail so that the front surface 322 and rear surface 324 of the upper rail are substantially coplanar with the front and rear surfaces, respectively, of the lower rail.

When exemplary miter fence assembly 300 is mounted on exemplary miter gauge 10, the front surfaces of the upper and lower rails form a workpiece support and alignment surface that is parallel to front surface 90 of the workpiece support member. Thus, the front surfaces are aligned at the miter angle relative to the feed direction. An operator can position and support a workpiece at the miter angle by holding the workpiece against the front surfaces of the upper and lower rails. In the exemplary embodiment, the upper and lower rails are 22 inches long, while the exemplary workpiece support member is 6 inches long. The larger length of the upper and lower rails allows exemplary fence assembly 300 to provide a substantially larger workpiece support surface than does miter gauge 10 without the fence assembly.

While the exemplary miter fence assembly allows an operator to align and support a workpiece at the desired miter angle, exemplary flip stop mechanism 330 allows the operator to position the workpiece accurately and precisely in a direction lateral to the feed direction so that the desired line of cut through the workpiece is aligned with the front of the blade or other shaper component. Flip stop mechanism 330 is configured to releasably clamp to the top of upper rail 320 and provide a rigid reference surface against which an edge of a workpiece, such as left edge 26 of sample workpiece 12, may be positioned. Exemplary flip stop mechanism 330 is used to position a workpiece along the length of the fence assembly so that the desired line of cut on the workpiece is aligned with the blade. Thus, by placing rear edge 24 of the workpiece against the front surfaces of the upper and lower rail and simultaneously placing left edge 26 against the flip stop reference surface, an operator can position a workpiece at the desired miter angle and aligned with the desired line of cut into the workpiece.

When unclamped from the upper rail, flip stop mechanism 330 is slidable along the top of the upper rail until the desired distance from the blade is achieved. At which point, the flip stop mechanism can be clamped to the upper rail to prevent it from being displaced. A linear ruled scale or ruler 332 is mounted to the top of upper rail 320 to enable an operator to easily see the position of the flip stop mechanism relative to the end of the upper rail. By adjusting the position of the fence assembly relative to the blade, an operator can ensure the ruler indicates the accurate distance from the blade. In one embodiment for example, the ruler may begin at 0.5 inches. Therefore, by placing the end of the upper rail at a distance of 0.5 inches from the blade, the ruler will read accurately relative to the blade. Alternatively, the upper rail may be positioned at a known offset from the blade and the offset may be added to the ruler measurement to obtain an accurate reading.

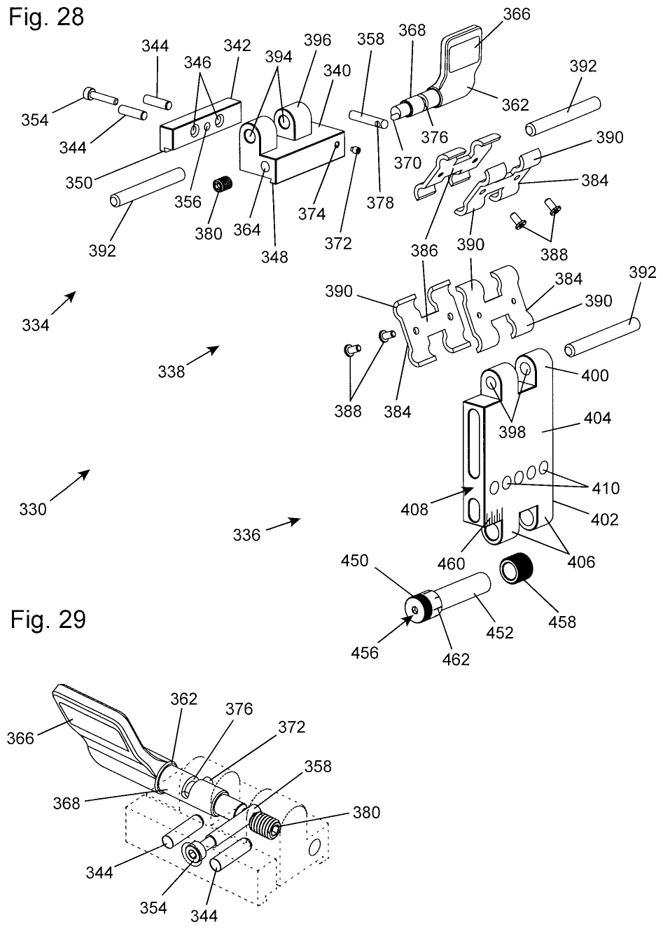

As shown in FIGS. 28-31. exemplary flip stop mechanism 330 includes a mount or clamp assembly 334 which is configured to releasably grip the top of the upper rail, a reference block assembly 336 which is selectively positionable adjacent the workpiece support surface to provide a reference surface for positioning a workpiece, and a linkage assembly 338 which movably connects the reference block assembly to the clamp assembly. The clamp assembly is manually operable to switch between “clamped” and “unclamped” conditions. When the clamp assembly is in an unclamped condition, the flip stop mechanism can be slid along the top of the upper rail to a desired position. Conversely, when the clamp assembly is in a clamped condition, the flip stop mechanism cannot be moved relative to the upper rail, thereby ensuring the flip stop mechanism is not accidentally displaced from the desired position.

The exemplary clamp assembly includes a clamp base 340 and a clamp block or jaw 342 that is constrained to move in a linear direction relative to the clamp base by a pair of guide pins 344 which are press-fitted into holes (not shown) in the side of the clamp base. The guide pins pass through holes 346 in the clamp jaw which are slightly larger in diameter than the guide pins, enabling the clamp to slide freely along the elongate axes of the guide pins. The clamp base is formed with a sloped ledge 348 extending downward and inward from the bottom edge of the clamp base opposite the clamp jaw. Similarly, the clamp jaw is formed with a sloped ledge 350 extending downward and inward from the bottom edge of the clamp jaw opposite the clamp base. The ledges on the clamp base and clamp jaw are shaped to engage and grip matching ledges 352 which extend upward and outward from both elongate upper edges of the upper rail.

The position of the clamp jaw along guide pins 344, and therefore the position of the clamp jaw relative to the clamp base, is controlled by the position of a piston bolt 354.

The shaft of the piston bolt passes through a central hole 356 in the clamp jaw and is threaded into one end of a connecting rod 358. The connecting rod is positioned substantially within a cylindrical bore 360 in the clamp base. Thus, as the connecting rod moves axially within bore 360, the piston bolt moves toward and away from the clamp base. The position of the connecting rod within bore 360 is driven by a clamp control arm 362 which extends partially into one end of a hole 364 through the clamp base. Hole 364 extends through the clamp base in a direction that is lateral to the cylindrical bore and passes through the bore to the opposite side of the clamp base.

The end of clamp control arm 362 which is positioned outside of the clamp base is formed as a handle 366. The middle section of the clamp control arm is formed as a shaft 368 which rotates within hole 364, while the end of the clamp control arm opposite the handle is formed as a pin 370 whose axis is offset from the rotational axis of the shaft. The offset of pin 370 from the rotational axis of shaft 368 causes the pint to revolve about the rotational axis when the control arm is rotated. A set screw 372 is threaded into a hole 374 in the clamp base until the end of the set screw engages a slot 376 formed partially around the outer circumference of shaft 368. When the control arm is rotated, the set screw rides within the slot until contacting either end of the slot, at which point further rotation of the control arm is prevented by the set screw. The length and position of the slot limits the full allowable rotation of the control arm to approximately 180 degrees. This rotational limit of the control arm constrains the orbit through which pin 370 moves to approximately 180 degrees, with one endpoint displaced from the rotational axis of shaft 368 toward the clamp jaw and the other endpoint displaced away from the clamp jaw.

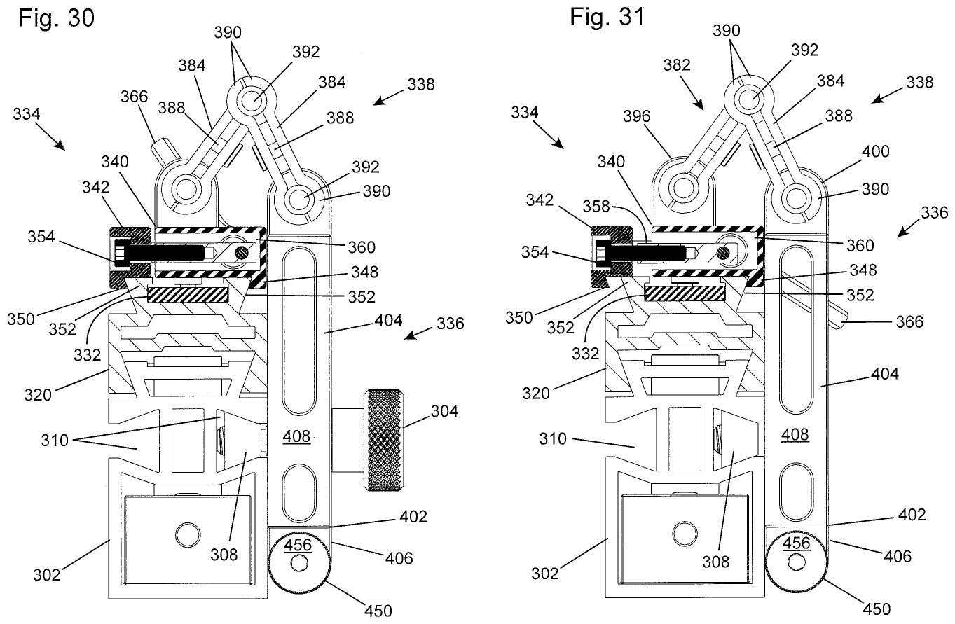

Pin 370 extends through a hole 378 on the end of connecting rod 358 opposite piston bolt 354. A set screw 380 is threaded into hole 364 on the clamp base from a direction opposite the clamp control arm. Set screw 380 is positioned close to, or in contact with, the end of pin 370 to prevent the connecting rod from sliding off of the pin. The diameter of hole 378 is slightly larger than the outer diameter of the pin, allowing the pin to rotate within the hole. As the clamp control arm is rotated in a counter-clockwise direction (as viewed from the handle) away from the clamp jaw, pin 370 moves away from the clamp jaw and pulls connecting rod 358 further into cylindrical bore 360. This movement causes the piston bolt to also move further into the bore. As a result, the head of the piston bolt pulls the clamp jaw toward the clamp base, causing the clamp base and clamp jaw to grip and clamp onto the top of the upper rail. FIG. 30 shows the exemplary clamp assembly when it is clamped to the upper rail, which is also referred to herein as the clamp assembly being in a “clamped condition.”

Conversely, when the clamp control arm is rotated in a clockwise direction toward the clamp jaw, pin 370 moves toward the clamp jaw and pushes connecting rod 358 partially out of cylindrical bore 360. This movement also pushes the piston bolt toward the clamp jaw, thereby allowing the clamp jaw to move away from the clamp base and releasing the clamping pressure on the upper rail. FIG. 31 shows the exemplary clamp assembly when it is not clamped to the upper rail, which is also referred to herein as the clamp assembly being in an “unclamped condition.”

Exemplary linkage assembly 338 is formed of a pair of hinges or links 382 which are pivotally connected to one another. Additionally, one link is pivotally connected to the clamp assembly, while the other link is pivotally connected to the reference block assembly. The pivotal connection between the links, the pivotal connection between one link and the clamp assembly, and the pivotal connection between the other link and the clamp assembly all pivot about axes which are substantially parallel to the elongate axis of the upper rail. As a result, the reference block assembly can be moved in a partial orbit around the upper rail. However, as will be discussed in more detail below, the reference surface remains constrained to a perpendicular orientation relative to the workpiece support surface of miter fence assembly 300.

Each link includes a pair of generally H-shaped link brackets 384 having midsections 386 which are fastened together by a pair of screws 388. The brackets are formed with generally circular curved flanges 390 that extend outward in both directions from the midsection. When the two brackets are fastened together, the flanges on each end form two generally circular, concentric, and open-ended rings whose widths can be adjusted by loosening or tightening screws 388. Hinge pins 392 are sized fit and rotate within the rings. The tightness of screws 388 is adjusted to create an amount of rotational friction between the hinge pins and flanges which supports reference block assembly 336 in a stationary position relative to the fence assembly, while still allowing an operator to easily move the reference block as needed.

The two links are connected together by one of the hinge pins which is positioned within the rings at one end of each of the links. The link flanges are interlaced so that the links cannot separate without removing the hinge pin. The opposite end of one link is pivotally connected to the clamp assembly by a hinge pin that passes through the rings and matching holes 394 in two bosses 396 formed on the top of clamp base 340. The flanges of the link are interlaced with the bosses to ensure the link cannot be separated from the clamp base without removing the hinge pin. The other link is pivotally connected to the reference block assembly by a hinge pin that passes through the remaining rings on the link and matching holes 398 in two bosses 400 formed on the top of reference block 402. The flanges of the link are interlaced with the bosses to ensure the reference block cannot be separated from the link without removing the hinge pin. In summary, reference block assembly 336 is movably coupled to clamp assembly 334 by the two links formed by the link brackets and hinge pins.

Exemplary reference block 402 is in the form of a generally rectangular section 404 extending between upper bosses 400 and lower bosses 406. Section 404 includes a flat surface or face 408 which is perpendicular to the pivot axes of hinge pins 392. As a result, surface 408 is also perpendicular to the workpiece support and alignment surface formed by the front surfaces of the upper and lower rails. Furthermore, the bottom edge of the clamp base lies within the plane formed by surface 408. Since the position of the flip stop mechanism relative to the blade is indicated on upper ruler 332 by the location of the bottom edge of the clamp base along the upper ruler, the ruler also indicates the distance from the blade to surface 408. Thus, surface 408 functions as a workpiece positioning surface against which an edge of a workpiece can be placed to position that edge of the workpiece at a known distance from the blade. By holding the rear edge of a workpiece against the workpiece support surface of the miter fence and the left edge of the workpiece against workpiece positioning surface 408, an operator can support the workpiece at the desired miter angle and line of cut while moving the workpiece into contact with the blade.

Although exemplary linkage assembly 338 is configured to hold reference block 402 and positioning surface 408 in a stable position, the reference block also includes through holes 410 which can be used to prevent accidental deflection by locking the reference block to the fence assembly. For example, as shown in FIG. 30, an operator may lock the reference block to the fence assembly by passing a thumb screw 304 through one of through holes 410 and tightening the screw into a wedge block 308 to clamp the reference block against the fence assembly. Of course, as shown in FIG. 31, when the clamp mechanism is unclamped and the operator is moving the flip stop mechanism along the upper rail, the thumb screw must be removed to allow the reference block to be repositioned.

As discussed above, the distance between the positioning surface and the blade can be decreased by sliding the flip stop mechanism along the upper rail toward the blade. Indeed, the reference surface can be placed less than a fraction of an inch from the blade to allow small cuts. However, the travel of the flip stop mechanism away from the blade is limited by the length of the upper rail. In other words, the flip stop mechanism must remain on the upper rail to function as intended. Thus, if an operator wishes to place the positioning surface at a distance from the blade that is further from the blade than the length of the fence assembly, the operator must move the upper rail along with the flip stop mechanism. One way to do this is to loosen the thumb screws that clamp the fence assembly to the miter gauge assembly, and then move the entire fence assembly away from the blade. However, there is a limit to how far the fence assembly can be moved while remaining attached to workpiece support member 76. Furthermore, moving the entire fence assembly relative to the blade will prevent the upper ruler from accurately indicating the position of the positioning surface.

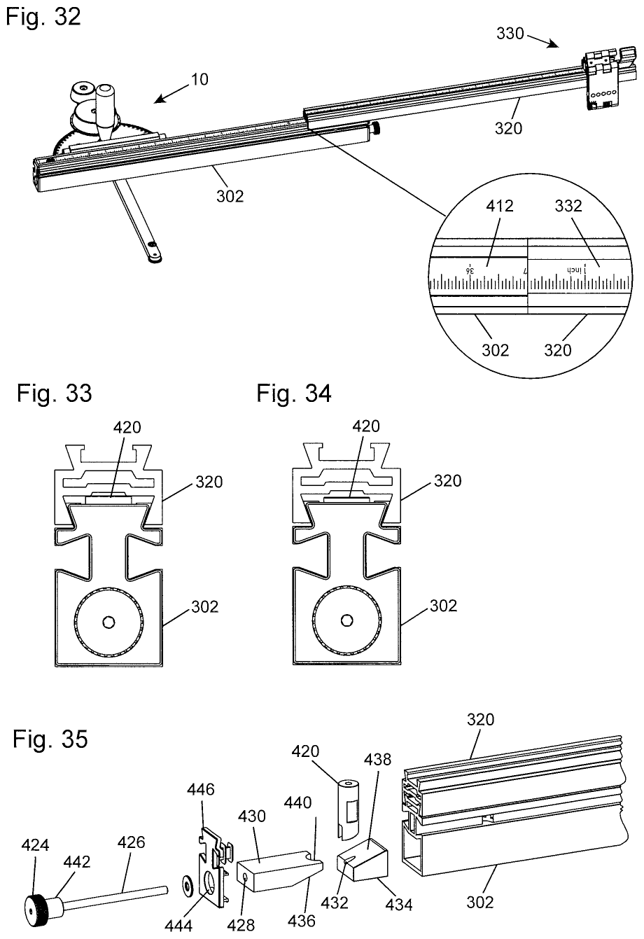

To overcome these issues, exemplary miter fence assembly 300 is configured such that the upper rail can be moved relative to the lower rail. Since the flip stop mechanism is clamped to the upper rail, the flip stop mechanism moves with the upper rail. As shown in FIG. 32, the effective length of the fence assembly can be extended by sliding the upper rail along the lower rail and away from the blade. The flip stop mechanism, which is clamped to the end of the upper rail opposite the miter gauge assembly, is also moved further from the blade. Thus, the allowable distance between the blade and the positioning surface is much greater than would be possible by simply moving the flip stop mechanism to the end of the upper rail.

To enable an operator to accurately determine the distance between the positioning surface and the blade when the upper rail is extended, a lower ruler 412 is mounted on the top of lower rail 302. As the upper rail slides along the lower rail, the lower ruler is increasingly exposed from underneath the upper rail. The readings on the lower ruler begin at the maximum reading of the upper ruler. In the exemplary embodiment, the length of the upper rail allows a maximum distance of 19 inches between the positioning surface and the blade. Accordingly, the lower ruler begins at a reading of 19 inches and increases in value.

The maximum distance the upper rail can move over the lower rail in the exemplary embodiment is approximately 18 inches, for a combined maximum distance of approximately 37 inches between the blade and the positioning surface. Thus, the position of the flip stop mechanism positioning surface is indicated by the reading of the lower ruler which is just under the edge of the upper rail. This reading is illustrated in the zoomed-in circle callout of FIG. 32, in which the lower ruler indicates the positioning surface is at the maximum distance of about 37 inches from the blade.

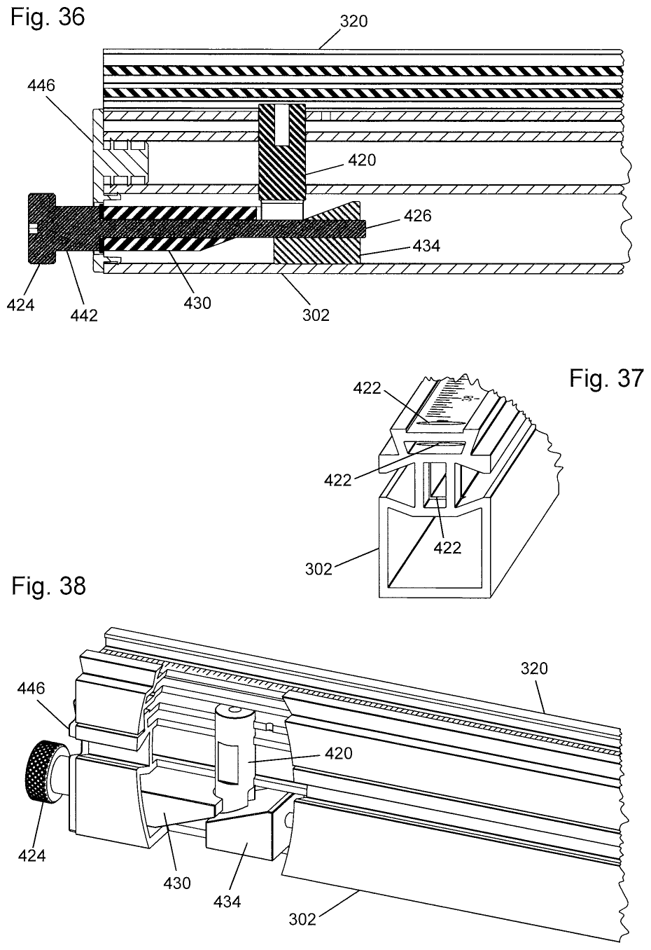

To prevent the upper rail from sliding along the lower rail when not intended, exemplary fence assembly 300 includes a rail lock mechanism configured to releasably lock the upper rail to the lower rail. As shown in FIGS. 33-38, The rail lock mechanism includes a locking cylinder 420 which slides vertically within a hole 422 in the lower rail. When the locking cylinder is pushed fully upward, it contacts the bottom of the upper rail and pushes the upper rail upward away from the lower rail to the limit allowed by the dovetail joint between the upper and lower rails. This condition, which is illustrated in FIG. 33, is referred to as the “locked” condition because the locking cylinder frictionally locks the upper rail against the lower rail at the dovetail joint. Conversely, when the locking cylinder is lowered in hole 422 as shown in FIG. 34, it no longer contacts the upper rail. This condition is referred to as the “unlocked” condition because the upper rail is not frictionally locked against the lower rail.

An operator can raise or lower locking cylinder 420 by turning locking thumb screw 424. The locking thumb screw has a relatively long shaft 426 which passes through a hole 428 in a guide block 430, and threads into a hole 432 in a platform block 434. The bottom of the guide block includes a sloped surface 436 which slides over a sloped surface 438 on the top of platform block 434. The bottom of locking cylinder 420, which is also sloped, rests on sloped surface 438 of the platform block. The locking cylinder is prevented from sliding off the sloped surface by guide block 430 which includes a curved notch 440 which holds the locking cylinder in place on top of the platform block. The vertical position of the locking cylinder within the lower rail is determined by its position on the sloped surface of the platform block.

When locking thumb screw 424 is rotated in a clockwise direction, the platform block is pulled toward the guide block, causing the locking cylinder to be pushed up the slope of the platform block. This causes the locking cylinder to rise within hole 422 until it contacts the bottom of the upper rail. As the locking thumb screw is turned further clockwise, the locking cylinder pushes the upper rail upward until it is locked against the lower rail. Conversely, when the locking thumb screw is rotated in a counter-clockwise direction, the platform block is pushed away from the guide block, allowing the locking cylinder to slide down the sloped surface of the platform block. This causes the locking cylinder to lower within hole 422 until the upper rail is no longer locked against the lower rail.

The locking thumb screw includes a hub portion 442 which fits within a hole 444 on an endcap 446 that frictionally grips the end of the lower rail. A washer 448 is positioned on the shaft of the locking thumb screw between the hub portion and the guide block to reduce the friction between the guide block and hub portion when the locking thumb screw is rotated. In summary, an operator can extend the upper rail and move the flip stop mechanism away from the blade by first unlocking the rail lock mechanism, then sliding the upper rail along the lower rail to the desired position, and finally locking the rail lock mechanism to prevent displacement of the upper rail and flip stop mechanism from the desired position.

As described above, exemplary flip stop mechanism 330 provides a positioning surface against which a lateral edge of a workpiece can be placed to position the workpiece along the desired line of cut. The rulers on the upper and lower rails indicate the distance between the blade and the positioning surface, thereby allowing an operator to change the location of the positioning surface both quickly and accurately. However, for shaping operations that require even more precision in the position of the workpiece, exemplary flip stop mechanism 330 includes a micro-adjust mechanism configured to enable very small and precise adjustments to the positioning surface.

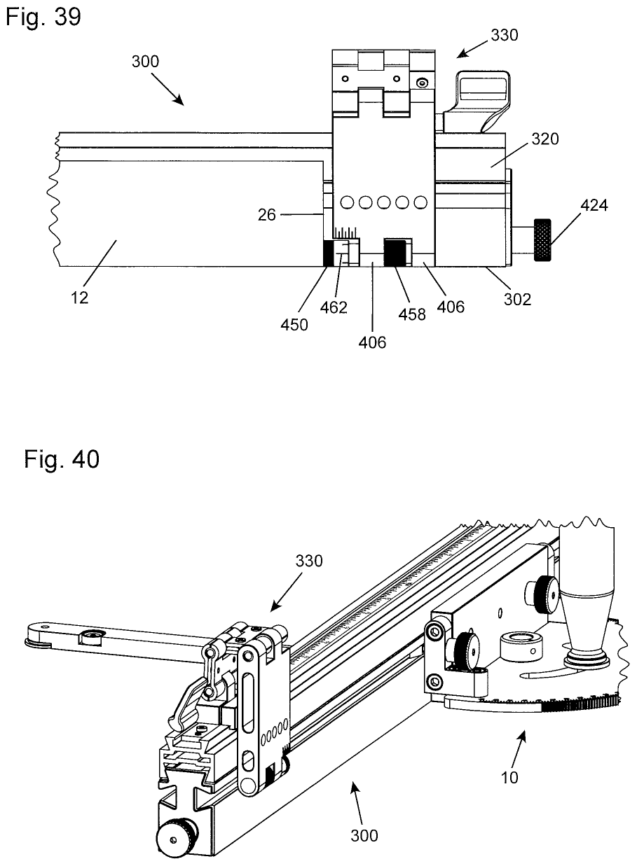

As shown in the exploded view of FIG. 28, the flip stop mechanism includes a precision thumb screw 450 with a shaft 452 which passes through a hole formed through the lower boss 406 which is adjacent reference surface 408, and then threads into a hole in the lower boss which is on the opposite side of reference block 402. When the precision thumb screw is fully threaded into the lower boss, the circular flat surface 456 on the head of the thumb screw is either flush with or slightly recessed from surface 408. As a result, the precision thumb screw does not affect the position of a workpiece. However, as the precision thumb screw is rotated counter-clockwise, surface 456 moves outward past surface 408. As shown in FIG. 39, when a workpiece is then placed against the flip stop mechanism, the edge of the workpiece will contact surface 456 rather than surface 408. In other words, surface 456 becomes the positioning surface of the flip stop mechanism. A lock nut 458 is threaded on shaft 452 between lower bosses 406 which can be tightened to lock the precision thumb screw at the desired location.

In the exemplary embodiment, the pitch of the threads on precision thumb screw 450 are 0.0625 inch or 1/16^{th} inch. Thus, one full counter-clockwise revolution of the precision thumb screw will move surface 456 outward by 1/16^{th} inch. This allows an operator a very high degree of precision when adjusting the position of the workpiece. The area of section 404 just above the head of precision thumb screw 450 is marked with a linear ruled scale 460 with indicia at 1/16^{th} inch increments. Additionally, the head of the precision thumb screw includes a circular ruled scale 462 with 8 indicia evenly spaced around the circumference of the head to indicate rotational increments of ⅛^{th} of a rotation or 45 degrees. Linear scale 460 and circular scale 462 combine to form a Vernier scale whereby an operator can read extremely precise increments. For example, each indicia on the circular scale, which marks ⅛^{th} of a revolution of the screw, corresponds to a movement of less than 0.08 inches by surface 456. Thus, an operator can use the precision thumb screw to make very precise and accurate adjustments in the position of the positioning surface. While the exemplary embodiment uses a particular thread pitch on the precision thumb screw as well as particular indicia increments on the linear and circular scales, it will be appreciated by those of skill in the art that different pitches and/or indicia increments may be used in alternative embodiments within the scope of this disclosure.

FIGS. 27, 30-32, and 39 all show exemplary flip stop mechanism in a position where the back surface of reference block 402 is contacting the front surfaces of the upper and lower rail, and where the bottom of the reference block is generally flush with the bottom of the lower rail. In this position the flip stop mechanism provides a positioning surface against which a workpiece can be placed to align the workpiece along a desired line of cut. This position is referred to herein as an “operative position” of the flip stop reference block. However, when the flip stop mechanism is not needed for a particular shaping operation, the reference block can be moved to a “nonoperative position” such as shown in FIG. 40. Exemplary linkage assembly 338 allows an operator to move the reference block to a variety of different locations, including by “flipping” the reference block completely over the upper rail to a location adjacent the rear surfaces of the upper and lower rails. Thus, it is not necessary to remove the flip stop mechanism from the fence assembly when it is not needed.

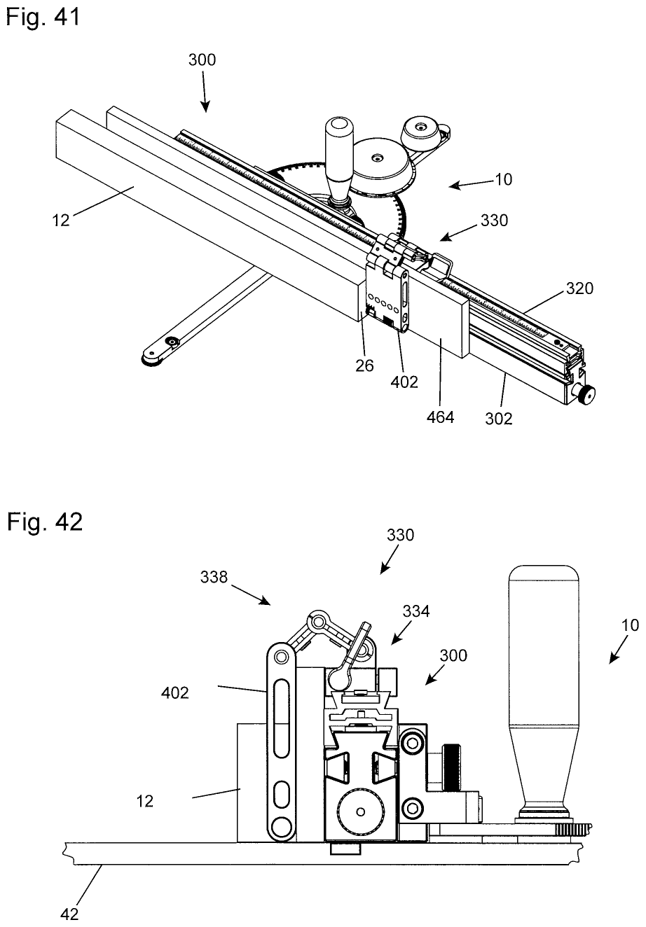

Another operative position of the flip stop mechanism is shown in FIGS. 41-42, in which the flip stop mechanism is positioned against a “sacrificial fence” 464. As is well-known in the field, sacrificial fences are typically wood, plastic, or similar pieces of material which can be cut or shaped by the shaper component of the workpiece shaping tool. The sacrificial fence can be positioned to provide support for the workpiece on both sides of the blade and be cut by the blade along with the workpiece. The rear surface of a sacrificial fence is typically placed against the workpiece support and alignment surface of a miter gauge or miter fence assembly, and thus the front surface of the sacrificial fence becomes the effective workpiece support and alignment surface against which a workpiece is held. Exemplary flip stop linkage assembly 338 allows the reference block to be positioned parallel to and in contact with the workpiece support surface of the sacrificial fence. In other words, the linkage assembly allows the reference block to positioned spaced apart from the front surfaces of the upper and lower rails, while still remaining parallel to those surfaces. As a result, the flip stop mechanism is in an operative position to provide a positioning surface adjacent the sacrificial fence.

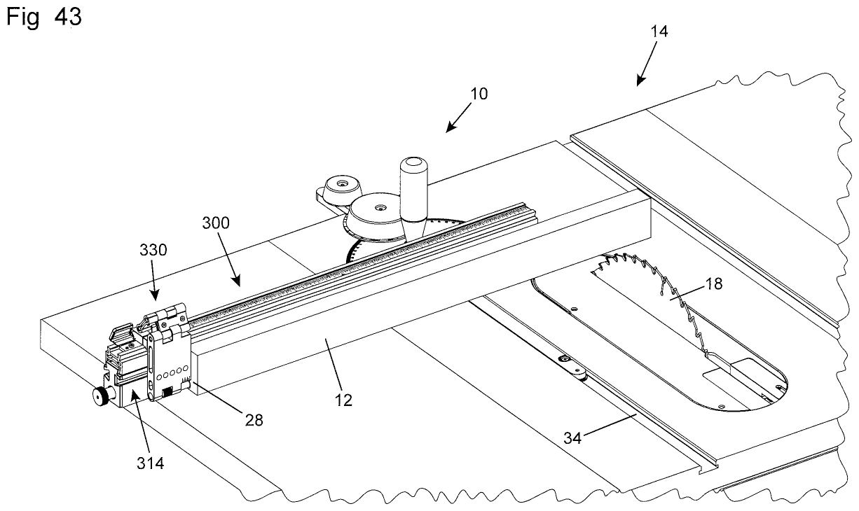

A further operative position of exemplary flip stop mechanism is shown in FIG. 43, in which exemplary fence assembly 300 has been reversed in its mounting to exemplary miter gauge assembly 10. This position is useful when an operator wishes to move the miter gauge to the miter slot on the other side of the blade. An operator can switch to this configuration by removing the thumb screws 304 which attach the fence assembly to workpiece support member 76, and then rotating the entire fence assembly 180 degrees so that the original front surfaces of the upper and lower rails are now in contact with the workpiece support member. If necessary, wedge blocks 308 can be moved from channels 310 on the old rear surface 314 of the lower rail to the identical channels in the old front surface 312. At which point, the thumb screws can be reinstalled to fasten the fence assembly to the miter gauge assembly in a reversed position. When the fence assembly is reversed on the miter gauge, surface 314 of the lower rail and surface 324 of the upper rail form the new workpiece support and alignment surface of the fence assembly.

It should be noted that changing the fence to this reversed position as illustrated in FIG. 43 does not require removing the exemplary flip stop mechanism from the fence assembly. The exemplary linkage assembly allows the flip stop mechanism to be used on either side of the fence without removing it from the fence. Instead, an operator need only flip the reference block assembly from the new rear side of the fence to the new front side. Since the reference block assembly is symmetric about the fence assembly, it functions identically on both sides of the fence. The positioning surface provided by the reference block is now adjacent the new workpiece support and alignment surface, and the rulers on the upper and lower rails continue to indicate the distance between the positioning surface and blade.

In summary, the positioning surface of exemplary flip stop mechanism 330 is easily movable between multiple different operative positions depending on the orientation of the fence assembly and the presence of a sacrificial fence. Alternatively, the positioning surface may be moved to any of a variety of nonoperative positions when not in use. Although one exemplary embodiment of flip stop mechanism 330 has been shown and described above, it will be recognized by those of skill in the art that a variety of alternative configurations, combinations, and arrangements are possible to provide the functionality of the exemplary embodiment, and that all such alternatives are within the scope of this disclosure.

### INDUSTRIAL APPLICABILITY

Miter gauges and fences as described herein are applicable to workpiece shaping tools such as table saws.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub-combinations of the various elements, features, functions and/or properties disclosed herein. No single feature, function, element, or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

We claim:

1. A miter gauge comprising:
an elongate member;
a support attached to the elongate member and configured to move relative to the elongate member;
an index configured to indicate a movement of the support relative to the elongate member in a predetermined amount, where the index includes discrete steps and each such step indicates the predetermined amount; and
a drive associated with the support, where the drive is rotatable, and where rotation of the drive moves the support through the discrete steps.

2. The miter gauge of claim 1, where the support pivots relative to the elongate member.

3. The miter gauge of claim 1, where the discrete steps are spaced at 1-degree increments.

4. The miter gauge of claim 1, further comprising a locking mechanism configured to hold the support so that the support does not move relative to the elongate member.

5. The miter gauge of claim 1, where the index is a first index, the movement is a first movement, the predetermined amount is a first predetermined amount, and the discrete steps are first discrete steps, and further comprising a second index configured to indicate a second movement of the support relative to the elongate member in a second predetermined amount different from the first predetermined amount, where the second index includes second discrete steps and each such step indicates the second predetermined amount.

6. The miter gauge of claim 5, where the first discrete steps are spaced at 1-degree increments and the second discrete steps are spaced at half degree increments.

7. The miter gauge of claim 5, further comprising a moveable member, where the moveable member is configured to selectively engage the drive with the first index or with the second index so that rotation of the drive moves the support through the first discrete steps or the second discrete steps.

8. The miter gauge of claim 1, where the index includes a surface and where each discrete step comprises a recess in the surface, and further comprising a ball detent configured to extend into each recess as the drive moves the support through the discrete steps.

9. The miter gauge of claim 1, where the drive is configured to provide tactile feedback to a user as the drive moves the support through the discrete steps.

10. The miter gauge of claim 1, where the support comprises an angle dial and a fence.

11. The miter gauge of claim 1, where the drive comprises a disk.

12. The miter gauge of claim 11, where the disk has a top face and a bottom face, and where the index is on the bottom face.

13. The miter gauge of claim 1, where the drive includes a gear that rotates to move the support.

14. The miter gauge of claim 13, where the support includes teeth that mesh with the gear.

15. The miter gauge of claim 14, where the drive comprises a disk configured to be grasped by a user and rotated, where the disk has a top and a bottom, and where the gear is adjacent the bottom.

16. The miter gauge of claim 1, where the drive includes a gear that rotates to move the support, where the support has an arcuate edge with a plurality of teeth along the arcuate edge, and where the gear meshes with the teeth along the arcuate edge.

17. The miter gauge of claim 16, further comprising an eccentric to move the teeth relative to the gear.

18. A miter gauge comprising:
an elongate member;
a support attached to the elongate member and configured to move relative to the elongate member;
index means for indicating a movement of the support relative to the elongate member in a predetermined amount; and
drive means for moving the support.

19. A miter gauge comprising:
a guide bar with a top surface;
a support attached to the guide bar and configured to move relative to the guide bar, where the support has an arcuate edge and teeth along the arcuate edge;
a drive associated with the support, where the drive includes a rotatable gear mounted adjacent the top surface of the guide bar and positioned to mesh with the teeth along the arcuate edge of the support, and where rotation of the gear moves the support.

20. The miter gauge of claim 19, further comprising an index configured to indicate a movement of the support relative to the guide bar in a predetermined amount, where the index includes discrete steps and each such step indicates the predetermined amount; and where rotation of the gear moves the support through the discrete steps.

21. A miter gauge for a workpiece shaping tool having a workpiece feed direction, the miter gauge comprising:
a guide base configured to engage the workpiece shaping tool and to move relative to the workpiece shaping tool in a direction substantially parallel to the feed direction;
a workpiece alignment mechanism movably coupled to the guide base, and including a workpiece alignment surface configured to align a workpiece at a miter angle relative to the feed direction when the workpiece is held against the workpiece alignment surface, and where movement of the workpiece alignment mechanism relative to the guide base causes a change in the miter angle;
a drive mechanism rotatably coupled to the guide base and positioned to contact the workpiece alignment mechanism, where rotation of the drive mechanism causes the workpiece alignment mechanism to move relative to the guide base; and
a drive control component which is operable by a person to manually rotate the drive mechanism and thereby change the miter angle.

22. A miter gauge for defining a miter angle relative to the feed direction of a workpiece shaping tool, where the workpiece shaping tool has a workpiece support surface adapted to support a workpiece as it is being shaped by the workpiece shaping tool, the miter gauge comprising:
a base configured to engage the workpiece shaping tool and maintain a predetermined orientation relative to the feed direction;
a miter angle reference surface pivotally coupled to the base,
where the angle between the miter angle reference surface and the feed direction, in a plane parallel to the workpiece support surface, defines a miter angle, and
where the miter angle changes when the miter angle reference surface pivots relative to the base;
a miter angle scale connected to the miter angle reference surface so as to pivot with the miter angle reference surface relative to the base,
where the miter angle scale includes a plurality of discrete, visible angle indicia,
where each angle indicia denotes a different angle value, and
where pivoting of the miter angle scale causes the plurality of angle indicia to consecutively pass through a first location; and
a miter angle indicator coupled to the miter angle scale such that the miter angle indicator moves relative to both the base and the miter angle scale when the miter angle scale pivots relative to the base,
where the miter angle indicator includes one or more discrete, visible indicator indicia disposed on the miter angle indicator so that movement of the miter angle indicator relative to the miter angle scale causes the one or more indicator indicia to pass through a second location, and
where the presence of any one of the plural angle indicia at the first location simultaneously with the presence of any one of the one or more indicator indicia at the second location, indicates that the miter angle is substantially equal to the angle value denoted by that one angle indicia present at the first location.

23. The miter gauge of claim 22, where the first location is closely adjacent the second location such that the presence of any one of the plural angle indicia at the first location simultaneously with the presence of any one of the one or more indicator indicia at the second location, causes the one angle indicia to be directly adjacent and visually aligned with the one indicator indicia.

24. A miter gauge for a workpiece shaping tool having a workpiece support surface and a feed direction, the miter gauge comprising:
a base configured to engage the workpiece shaping tool and to move, relative to the workpiece shaping tool, in a direction parallel to the feed direction;
a workpiece alignment mechanism coupled to move with the base and to pivot relative to the base, and including a workpiece alignment surface, where the angle between the workpiece alignment surface and the feed direction, in a plane parallel to the workpiece support surface, defines a miter angle;
an operative component that is movable by a person to manually pivot the workpiece alignment mechanism and thereby change the miter angle; and
a detent feedback mechanism coupled to the workpiece alignment mechanism and to the operative component, and including
a first set of one or more detent structures, where each detent structure in the first set corresponds to a first increment of angular change in the miter angle,
a second set of one or more detent structures, where each detent structure in the second set corresponds to a second increment of angular change in the miter angle, and where the second increment is a smaller increment of angular change than the first increment,
at least one tactile stimulus generator configured to consecutively engage the one or more detent structures within a set of detent structures, and to generate a discrete tactile stimulus upon engaging each detent structure,
where the detent feedback mechanism is manually-adjustable to select which one of either the first or second set of detent structures the at least one tactile stimulus generator engages;
where the coupling between the detent feedback mechanism and the workpiece alignment mechanism causes the tactile stimulus generator to consecutively engage the detent structures of the selected set of detent structures when the operative component is moved to pivot the workpiece alignment mechanism, and to thereby generate a distinct tactile stimulus each time the miter angle changes by the angular increment corresponding to the selected set of detent structures; and
where the coupling between the detent feedback mechanism and the operative component causes each tactile stimulus generated by the tactile stimulus generator to be transmitted to the operative component so as to be sensed by a person moving the operative component.

25. A miter gauge assembly for aligning a workpiece relative to the feed direction of a workpiece shaping tool, where the workpiece has at least a first workpiece edge and a second workpiece edge that is generally perpendicular to the first workpiece edge, the miter gauge assembly comprising:
a base configured to engage the workpiece shaping tool and maintain a predetermined orientation relative to the feed direction;
a miter angle adjustment mechanism including an alignment structure pivotally coupled to the base, where the alignment structure includes one or more attachment surfaces;
a reversible miter fence removably attached to the one or more attachment surfaces so as to pivot with the alignment structure, and configured to align a workpiece at a miter angle relative to the feed direction,
where the miter fence includes a first fence face, a second fence face, and a mounting region,
where the miter fence is attachable to the alignment structure in a selected one of at least two orientations, including a first orientation in which the first fence face contacts the one or more attachment surfaces and the second fence face is positioned to align a workpiece at the miter angle, and a second orientation in which the second fence face contacts the one or more attachment surfaces and the first fence face is positioned to align a workpiece at the miter angle, and
where the miter angle changes when the miter fence pivots with the alignment structure;
a flip-stop mount attached to the mounting region of the miter fence; and
a flip-stop block movably connected to the flip-stop mount and having a workpiece positioning surface,
where the flip-stop block is movable, relative to the flip-stop mount, between a first operative position and a second operative position,
where the workpiece positioning surface is positioned to contact the second workpiece edge when the flip-stop block is in the first operative position and the first workpiece edge is held against the first fence face, and
where the workpiece positioning surface is positioned to contact the second workpiece edge when the flip-stop block is in the second operative position and the first workpiece edge is held against the second fence face.

26. A miter gauge comprising:
a guide bar,
a frame pivotally mounted to the guide bar,
a handle configured to be rotated by a person by hand without tools, and
a gear interconnecting the handle and the frame, where rotation of the handle causes the gear to move, and where movement of the gear causes the frame to pivot relative to the guide bar.
